(19) United States
(12) Patent Application Publication
(10) Pub. No.: US 2007/0041511 A1
(43) Pub. Date: Feb. 22, 2007

(54) Apparatus and method for processing a signal under test for measuring the impedance of a device under test

(76) Inventors: Kan Tan, Beaverton, OR (US); John J. Pickerd, Hillsboro, OR (US); Ping Qiu, Beaverton, OR (US)

Correspondence Address: THOMAS F. LENIHAN;TEKTRONIX, INC., 14150 S. W. KARL BRAUN DRIVE, P.O. BOX 500 (50-LAW), BEAVERTON, OR, 97077-0001, US

(21) Appl. No.: 11/441,733

(22) Filed: May 25, 2006

Related U.S. Application Data
(63) Continuation-in-part of application No. 11/361,558, filed on Feb. 24, 2006.
Application No. 11/361,558 is a continuation-in-part of application No. 11/045,413, filed on Jan. 27, 2005.

(51) Int. Cl. H04M 1/24

(52) U.S. Cl. 379/30

(57) ABSTRACT

A method and apparatus adapted to calibrate a test probe and oscilloscope system such that digital samples of a signal under test acquired by the system are processed for representing the impedance of a device under test. The method and apparatus calibrates the test probe to characterize transfer parameters of the device under test within a spectral domain. A reference impedance (Z_{ref}) is retrieved that is associated with the transfer parameters and the characteristic impedance of an oscilloscope system coupled to the device under test. The transfer parameters of the device under test and the reference impedance (Z_{ref}) are processed to effect thereby a representation of the device under test impedance (Z_{eq}) as a function of frequency.

### CROSS-REFERENCE TO RELATED APPLICATION

This continuation-in-part application claims the benefit of priority of continuation-in-part U.S. patent application Ser. No. 11/361,558, filed Feb. 24, 2006 which claims the benefit of priority of U.S. patent application Ser. No. 11/045,413, filed Jan. 27, 2005 which claims the benefit of priority of U.S. patent application Ser. No. 10/786,446, filed Feb. 25, 2004.

### FIELD OF THE INVENTION

The invention relates generally to signal acquisition systems and, more particularly, to a system, apparatus and method for processing acquired digital samples of a test signal from device under test for producing an output representing an impedance of the device under test

### BACKGROUND OF THE INVENTION

Typical probes used for signal acquisition and analysis devices such as digital storage oscilloscopes (DSOs) and the like have an impedance associated with them which varies with frequency. For example, a typical probe may have an impedance of 100K to 200K Ohms at DC, which impedance drops towards 200 ohms at 1.5 GHz. Higher bandwidth probes drop to even lower impedance values. This drop in impedance as frequency increases, coupled with the fact that many circuits being probed have a relatively low output impedance in the range of 25-150 ohms, results in a significant loading of the circuit under test by the probe. As such, an acquired waveform received via a probe loading such a circuit may not accurately represent the voltage of the circuit prior to the introduction of the probe.

There is also a further need to process acquired samples of a signal from a device under test to produce an output representing the impedance of the device under test. Such a capability in a signal analysis system would allow a user to observe the impedance of the device under test.

### SUMMARY OF INVENTION

These and other deficiencies of the prior art are addressed by the present invention of a system, apparatus and method for processing acquired time domain digital samples of a signal under test from a device under test for producing an output representing the impedance of the device under test. Briefly, the invention provides a method to calibrate a probe and oscilloscope system by characterizing transfer parameters of the device under test within a spectral domain. The transfer parameters and a reference impedance associated with the transfer parameters and the characteristic impedance of the test system are used for generating a representation of the impedance of the device under test as a function of frequency. As a result, a user will see a display that represents the impedance of a circuit under test as a function of frequency.

Specifically, a signal analysis system according to one embodiment of the invention has a digitizing instrument having a memory for storing transfer parameters associated with the digitizing instrument and generating digital samples of a signal under test. A test probe provides the signal under test from a device under test to the digitizing instrument. The test probe has a memory for storing transfer parameters associated with the probe. A controllable impedance device having selectable impedance loads is selectively coupled to the device under test. A controller having associated memory communicates with the digitizing instrument and the test probe for selectively coupling impedance loads in the controllable impedance device to the device under test. The acquired time domain digital samples of the signal under test are converted to a spectral domain representation by the controller for each selected impedance load and the transfer parameters of the device under test within a spectral domain are characterized from the spectral domain representations for each selected impedance load. The controller retrieves a value representing the reference impedance (Z_{ref}) and computes at least a first impedance (Z_{eq}) of the device under test as a function of frequency using the characterized transfer parameters of the device under test and the reference impedance (Z_{ref}).

A method according to one embodiment of the invention acquires a plurality of time domain samples of a signal under test from a device under test via a signal path including a plurality of selectable impedance loads. The plurality of time domain samples are converted to a spectral domain representation for each selected impedance load of the plurality of impedance loads. Transfer parameters of the device under test are characterized within a spectral domain from the spectral domain representation for each of the selected impedance loads. A reference impedance (Z_{ref}) associated with the transfer parameters is retrieved and the transfer parameters of the device under test are processed with the reference impedance (Z_{ref}) in the spectral domain to effect thereby a representation of the device under test impedance (Z_{eq}) as a function of frequency.

The converting of the plurality of time domain samples of the signal under test from the device under test to spectral domain representations generates at least a first frequency component having a signal level. A threshold signal level may be defined and compared to the signal level of at least the first frequency component. The impedance (Z_{eq}) of the device under test is computed when the signal level of at least the first frequency component is greater than the threshold level. In the case where the conversion of the plurality of time domain digital samples to spectral domain representations generates a plurality of frequency component with each frequency component having a signal level, the threshold signal level is compared to the respective signal levels of plurality of frequency component. The impedance (Z_{eq}) of the device under test is computed for each of the plurality of frequency components when the respective signal level of each of the plurality of frequency components is greater than the threshold level.

The device under test may be a signal source and a passive circuit device being coupled to the signal source. In such a configuration, the processing of the a plurality of samples of the signal under test from a device under test further includes the steps of retrieving a value representing the reference impedance (Z_{ref}) and processing the acquired samples in the spectral domain from the signal source to effect thereby a representation of the signal source impedance (Z_{eq}^{source}) as a function of frequency. The signal source is coupled to the passive circuit device. The acquired samples from the passive circuit device are processed in the spectral domain to effect thereby a representation of the combined signal source and passive circuit device impedance (Z_{eq}^{comb}) as a function of frequency. The representations of the signal source impedance (Z_{eq}^{source}) and the combined signal source impedance and passive circuit device impedance (Z_{eq}^{comb}) in the spectral domain are processed to effect thereby a representation of the passive circuit device impedance (Z_{eq}^{PCD}) as a function of frequency.

### BRIEF DESCRIPTION OF THE DRAWINGS

The teachings of the present invention can be readily understood by considering the following detailed description in conjunction with the accompanying drawings, in which

FIG. 1 depicts a high level block diagram of a testing system including a device under test arranged in accordance with an embodiment of the present invention;

FIG. 2 depicts a high level block diagram of a signal analysis system;

FIG. 3 depicts a high level block diagram of a probe normalization fixture suitable for use in the system of FIG. 1;

FIG. 4 depicts an exemplary two-port model of a probe normalization test channel;

FIG. 5 depicts a flow diagram of a method for characterizing transfer parameters of a device under test according to an embodiment of the invention;

FIG. 6 illustrates one embodiment of a probe usable with the present invention;

FIG. 7 depicts a user interface screen suitable for use with the probe in an embodiment of the present invention;

FIG. 8 illustrates a device under test coupled to a reference impedance for describing an embodiment of the present invention;

FIG. 9 depicts a flow diagram of a method according to an embodiment of the present invention;

FIGS. 10A through 10D depict time domain waveforms and resulting FFT spectral domain representations of the time domain waveforms;

FIG. 11 illustrates a device under test consisting of a signal source and a passive circuit device coupled to a reference impedance for describing a further embodiment of the present invention;

FIG. 12 depicts a test fixture for implementing the further embodiment of the present invention;

FIGS. 13A through 13C depicts a flow diagram of the method according the further embodiment of the present invention;

FIG. 14A depicts a user interface screen suitable for use in an embodiment of the present invention;

FIG. 14B depicts a setup user interface screen suitable for use in an embodiment of the present invention; and

FIG. 14C depicts a further setup user interface screen suitable for use in an embodiment of the present invention.

To facilitate understanding, identical reference numerals have been used, where possible, to designate identical elements that are common to the figures.

### DETAILED DESCRIPTION OF THE INVENTION

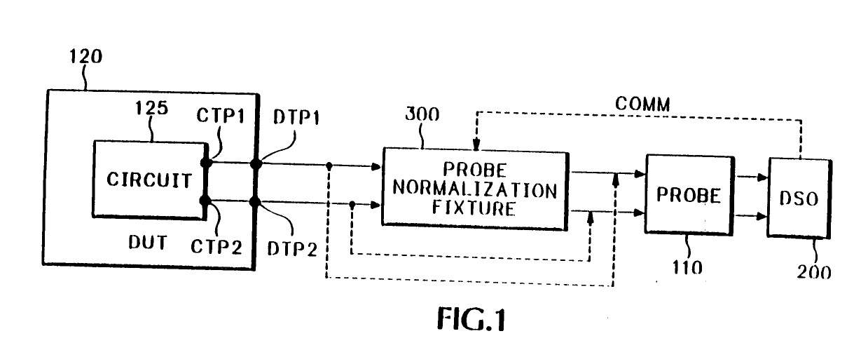

FIG. 1 depicts a high level block diagram of a testing system including a device under test arranged in accordance with an embodiment of the present invention. Specifically, a probe 110 is operably coupled to a signal analysis device such as a DSO 200 to provide thereto a signal under test (SUT) received from a device under test (DUT) 120. Interposed between the DUT 120 and the probe 110 is a probe normalization fixture 300.

In a calibrate mode of operation, the signal path between the DUT 120 and probe 110 passes through the probe normalization fixture 300. In a non-calibration mode of operation, a signal path between the DUT 120 and probe 110 is direct and excludes the probe normalization fixture 300. The calibration mode signal path is indicated by an unbroken line, while the non-calibration mode signal path is indicated by a dotted line. It will be noted that the probe paths depicted in FIG. 1 comprise two probe paths such as used within the context of a differential probe. In alternate embodiments, a single-ended or non-differential probe is used in which a first path passes a signal under test while a second path is operatively coupled to a common or ground point. Generally speaking, the normalization fixture is adapted to enable characterization of the device under test using switchable loads in the probe normalization fixture 300 such that an equalization filter may be computed. The equalization filter may be implemented in either the time domain or the frequency domain to be described in greater detail below. Upon removal of the normalization fixture from the signal path between the DUT 120 and probe 110, the equalization filter may be used to process the acquired samples from the DUT such that signal degradation or artifacts imparted to the SUT provided by the DUT are compensated for within the system, effectively de-embedding the loading of the DUT by the test and measurement system.

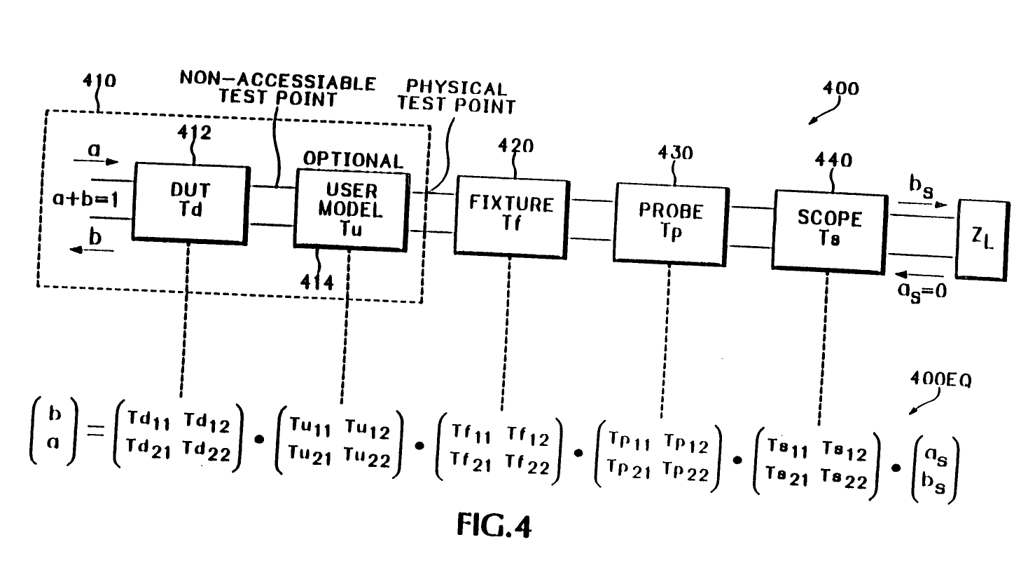

The (illustratively two) probe paths are coupled to the DUT 120 at a first device test point DTP1 and a second device test point DTP2. Optionally, internal to the DUT 120 is a circuit 125. The circuit 125 includes a first circuit test point CTP1 and a second circuit test point CTP2, where CTP1 is coupled to DTP1 and CTP2 is coupled to DTP2. For example, the DUT 120 may comprise an integrated circuit (IC) having a plurality of pins including pins associated with the test points DTP1 and DTP2, while a die within the IC includes the circuit test points CTP1 and CTP2. The difference in these tests points and the characterization of the operating parameters associated with these test points will be discussed in more detail below with respect to FIG. 4.

The invention operates to calibrate the probe 110 and, optionally, DSO input channel to remove (i.e., de-embed) their respective signal degrading effects from the measurement of the DUT (or circuit). This de-embedding process is conducted by characterizing the probe and other elements using a two-port S-parameter or T-parameter representation, which representation may be used to adjust impedance normalization parameters within the probe normalization fixture 300 and/or filter parameters used to process an acquired sample stream within the DSO 200

Optionally, a user may insert a mathematical model such as a two-port S-parameter or T-parameter representation into the signal measurement path to compensate for signal degradations or characteristics between the scope probe tip and the specific measurement point of a device under test. In this manner, an integrated circuit (IC) may be probed at its respective test point to provide, with mathematical compensation of the signal path between the test points (e.g., DTP1, DPT2) and the die interface (e.g., CTP1, CTP2), a voltage or signal for analysis that accurately represents the signal at the die itself. Generally speaking, the invention may utilize transfer parameters received from, e.g., the user that characterize a circuit between the test probe and the DUT such that the calculations of an equalization filter and the like are further adapted to compensate for loading of the DUT caused by the circuit between the probe and said DUT. Such insertion of additional transfer parameters is also useful in determining the effect of different intermediate circuitry (i.e., between a DUT or DUT portion and test probe) such as different die layout, packaging, DUT output circuitry and the like.

In one embodiment, the invention comprises a probe tip fixture that is inserted between a test probe and a device under test (DUT) and used during a one button press calibration procedure. This calibration procedure uses no external voltage sources, only the signal under test provided by the device under test. The probe test fixture contains multiple loads (resistive and/or reactive impedances) that are selected based on the probe and in response to the device under test or signal produced by the device under test. The multiple loads comprise series, parallel and/or series/parallel combinations of resistive, capacitive and/or inductive elements. The multiple loads may be passive or active and may be selected using relays, solid state switching devices, or other selecting means. The probe tip fixture may comprise a stand-alone unit adapted to receive the probe or may be incorporated into the probe itself.

In one embodiment, the multiple loads are arranged as a load or impedance matrix. In various embodiments, the invention provides a new method and associated probe normalization fixture that allows the effects of probing to be de-embedded from the measurement of a device under test.

The invention utilizes a two-port matrix of S-parameters or T-parameters to model each element associated with the measurement signal path. Optionally, some elements are not modeled. The T-parameters are used so that a two-port matrix for each of the elements of the system model may be computed in a straight forward manner by multiplying them in the order they occur in the signal path. T-parameters are transfer parameters and are derived from S-parameters.

T-parameters for the normalization fixture and/or probe may be stored in the fixture itself, the probe or the DSO. In one embodiment, T-parameters for the probe are stored in the probe while T-parameters for the fixture are stored in the fixture. The scope channel T-parameters are optionally stored in the DSO 200.

The signal provided by the DUT is used as the signal source for a calibration procedure. The scope collects measurements with each of at least some of the loads in the fixture and then computes the T-parameters for the DUT. Once this is known, the fixture is removed and the probe is connected to the calibrated test point in the DUT. A correction equalization filter based on the calibration is then applied to the acquired data such that the effects of probe loading as a function of frequency are removed or offset. The entire calibration process is automated and activated from, for example, a single menu button in the oscilloscope. It should be noted that the fixture may be left in place after the calibration process to improve accuracy by avoiding physical movement of the probing fixture (since slight changes in position can affect the calibration).

The relationship between S- and T-parameters will now be briefly discussed. It should be noted that while T-parameters are primarily described within the context of the invention, the use of S-parameters instead of T-parameters is also contemplated by the inventors. Thus, S-parameters may be substituted wherever the storage and/or use of T-parameters is discussed herein. T-parameters may be computed from the S-parameters at the time the algorithms are processed. The relationship between T- and S-parameters is given by equations 1 and 2 below:

$$\begin{matrix}( \begin{matrix}{T}_{11} & {T}_{12} \\ {T}_{21} & {T}_{22}\end{matrix} ) = ( \begin{matrix}- \frac{{S}_{11} {S}_{22} - {S}_{12} {S}_{21}}{{S}_{21}} & \frac{{S}_{11}}{{S}_{12}} \\ - \frac{{S}_{22}}{{S}_{21}} & \frac{1}{{S}_{21}}\end{matrix} ) & ( EQ 1 ) \\ ( \begin{matrix}{S}_{11} & {S}_{12} \\ {S}_{21} & {S}_{22}\end{matrix} ) = ( \begin{matrix}\frac{{T}_{12}}{{T}_{22}} & \frac{{T}_{11} \cdot {T}_{22} - {T}_{12} \cdot {T}_{21}}{{T}_{22}} \\ \frac{1}{{T}_{22}} & \frac{- {T}_{21}}{{T}_{22}}\end{matrix} ) & ( EQ 2 )\end{matrix}$$

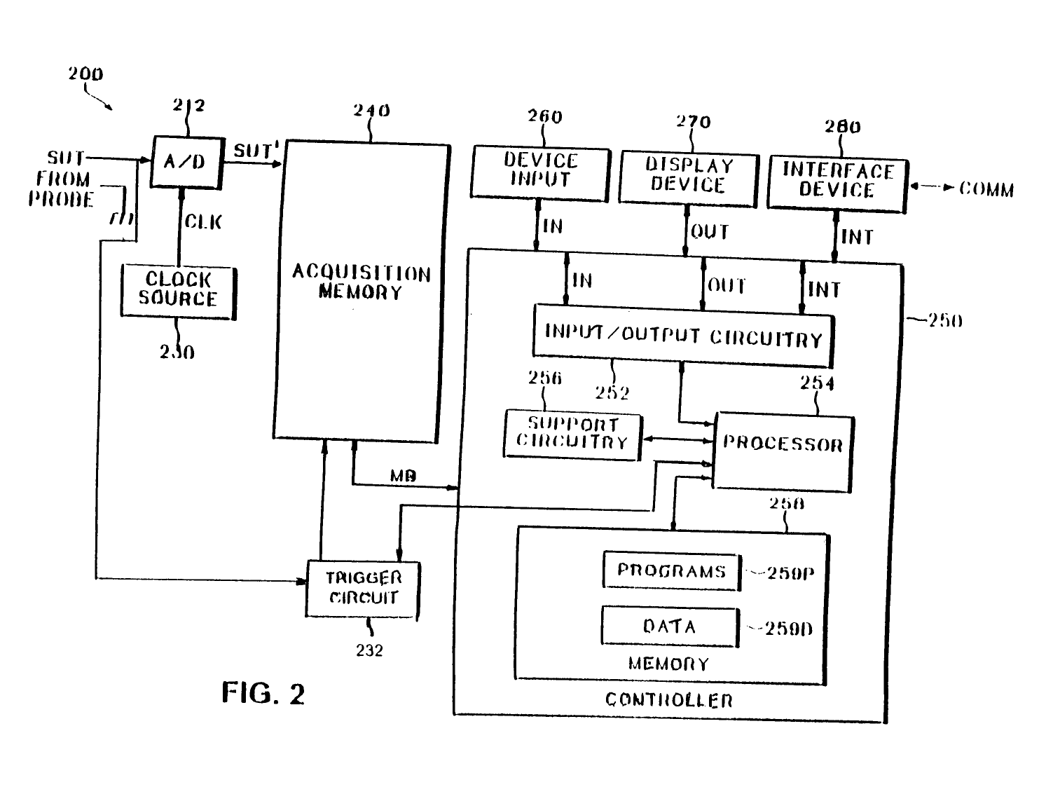

FIG. 2 depicts a high level block diagram of a signal analysis device such as a digital storage oscilloscope (DSO) suitable for use with the present invention. Specifically, the system (signal analysis device) 200 of FIG. 1 comprises an analog to digital (A/D) converter 212, a clock source 230, a trigger circuit 232, an acquisition memory 240, a controller 250, an input device 260, a display device 270 and an interface device 280. The A/D converter 212 receives and digitizes a SUT in response to a clock signal CLK produced by the clock source 230. The clock signal CLK is preferably a clock signal adapted to cause the A/D converter 212 to operate at a maximum sampling rate, though other sampling rates may be selected. The clock source 230 is optionally responsive to a clock control signal CC (not shown) produced by the controller 250 to change frequency and/or pulse width parameters associated with the clock signal CLK. It is noted that the A/D converter 212 receives the SUT via a probe (not shown), which probe may comprise a differential probe or a single ended (i.e., non-differential) probe.

A digitized output signal SUT′ produced by the A/D converter 212 is stored in the acquisition memory 240. The acquisition memory 240 cooperates with the controller 250 to store the data samples provided by the A/D converter 212 in a controlled manner such that the samples from the A/D converter 212 may be provided to the controller 250 for further processing and/or analysis.

The controller 250 is used to manage the various operations of the system 200. The controller 250 performs various processing and analysis operations on the data samples stored within the acquisition memory 240. The controller 250 receives user commands via an input device 260, illustratively a keypad or pointing device. The controller 250 provides image-related data to a display device 270, illustratively a cathode ray tube (CRT), liquid crystal display (LCD) or other display device. The controller 250 optionally with a communications link COMM, such as a general purpose interface bus (GPIB), Internet Protocol (IP), Ethernet or other communications link via the interface device 280. It is noted that the interface device 280 is selected according to the particular communications network used. An embodiment of the controller 250 will be described in more detail below.

The signal analysis device 200 is set-up by user commands from the input device 260 that establishes a trigger threshold and pre and post trigger times for the storing of the digital samples from the A/D converter 212. The digital samples are initially stored in a circular buffer in the acquisition memory. The circular buffer continuously stores digital samples from the A/D converter 212 with new digital samples overwriting older digital samples once the circular buffer is full. The trigger circuit 232 generates a trigger output to the acquisition memory upon the signal under test crossing the trigger threshold to stop the storing of digital samples in the circular buffer after the post trigger time. The contents of the circular buffer are stored as a waveform record within the acquisition memory 240.

The system 200 of FIG. 2 is depicted as receiving only one SUT. However, it will be appreciated by those skilled in the art that many SUTs may be received and processed by the system 200. Each SUT is preferably processed using a respective A/D converter 212, which respective A/D converter may be clocked using the clock signal CLK provided by common or respective clock source 230 or some other clock source. Each of the additional digitized SUTs is coupled to the acquisition memory 240 or additional acquisition memory (not shown). Any additional acquisition memory communicates with the controller 250, either directly or indirectly through an additional processing element.

The controller 250 comprises a processor 254 as well as memory 258 for storing various programs 259P (e.g., calibration routines) and data 259D (e.g., T- and/or S-parameters associated with one or more components within the testing system). The processor 254 cooperates with conventional support circuitry 256 such as power supplies, clock circuits, cache memory and the like, as well as circuits that assist in executing the software routines stored in the memory 258. As such, it is contemplated that some of the process steps discussed herein as software processes may be implemented within hardware, for example as circuitry that cooperates with the processor 254 to perform various steps. The controller 250 also contains input/output (I/O) circuitry 252 that forms an interface between the various functional elements communicating with the controller 250. For example, the controller 250 communicates with the input device 260 via a signal path IN, a display device 270 via a signal path OUT, the interface device 280 via a signal path INT and the acquisition memory 240 via signal path MB. The controller 250 may also communicate with additional functional elements (not shown), such as those described herein as relating to additional channels SUT processing circuitry, switches, decimators and the like. It is noted that the memory 258 of the controller 250 may be included within the acquisition memory 240, that the acquisition memory 240 may be included within the memory 258 of the controller 250, or that a shared memory arrangement may be provided.

Although the controller 250 is depicted as a general purpose computer that is programmed to perform various control functions in accordance with the present invention, the invention can be implemented in hardware as, for example, an application specific integrated circuit (ASIC). As such, the process steps described herein are intended to be broadly interpreted as being equivalently performed by software, hardware or a combination thereof.

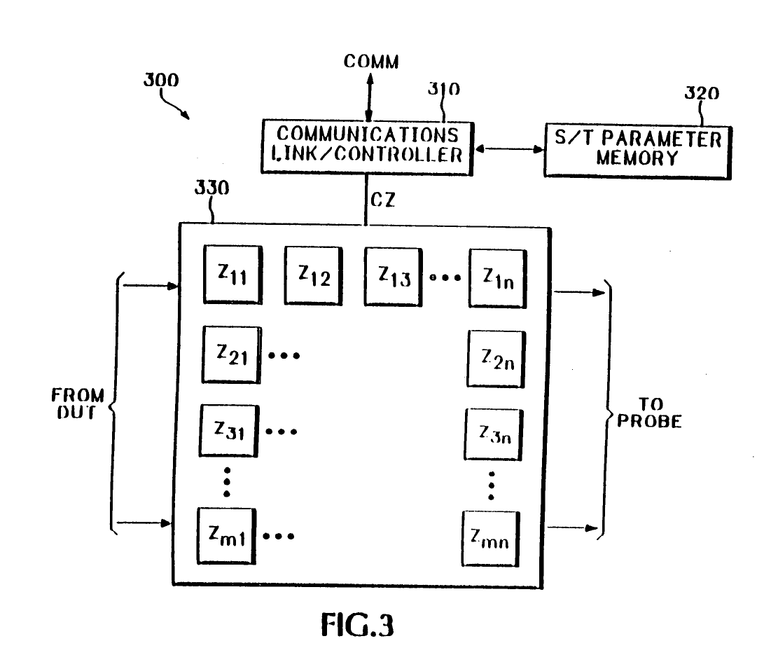

FIG. 3 depicts a high level block diagram of a probe normalization fixture suitable for use in the system of FIG. 1. Specifically, the probe normalization fixture 300 of FIG. 3 comprises a communication link/controller 310, an S- or T-parameter memory 320 and a selectable impedance matrix 330. The S/T parameter memory 320 is used to store S- or T-parameters associated with the probe 110 and, optionally, any of the DUT 120, circuit 125, DSO 200 or user supplied parameters. The parameters stored in the memory 320 are provided via, illustratively, the communication link/control circuit 310. The communication link/control circuit 310 is operatively coupled to a signal analysis device (e.g., a DSO), a computer (not shown) or other test system controller via a communication link COMM, illustratively an Ethernet, Universal Serial Bus (USB) or other communication link. The communication link/control circuit 310 also controls the selectable impedance matrix 330 via a control signal CZ.

The selectable impedance matrix 330 comprises a plurality of impedance elements Z arranged in matrix form. Specifically, a first impedance element in a first row is denoted as Z₁₁, while the last impedance element in the first row is denoted as Z₁ₙ. Similarly, the last impedance element in a first column is denoted as Zₘ₁, while the last impedance in the nth column is denoted as Zₘₙ. While depicted as an m×n grid or matrix of selectable impedance elements, it will be noted that a more simplified array of impedance elements may be provided. It is also noted that each of the impedance elements may comprise a resistive element, a capacitive element, an inductive element and any combination of active or passive impedance elements. The impedance matrix 330 may provide serial, parallel, serial and parallel or other combinations of passive or active impedances to achieve the purpose of impedance normalization between the DUT (or circuit) and probe 110.

Generally speaking, the purpose of the impedance element matrix 330 is to adapt the input impedance of the probe 110 to the output impedance of the DUT 120 (or circuit 125) such that undue loading of the measured signal parameters is avoided or at least reduced, while there is enough signal passed into probe. At the same time various load ranges must be provided so that adequate DUT loading occurs to provide good signal to noise ratio for the calibration procedure. The impedance matrix may be modified to provide additional normalization. That is, rather than normalizing just the probe 110, the probe normalization fixture 300 may also be used to normalize the probe 110 in combination with the input channel of the DSO 200 utilizing the probe 110. Various other permutations will be recognized by those skilled in the art and informed by the teachings of the present invention.

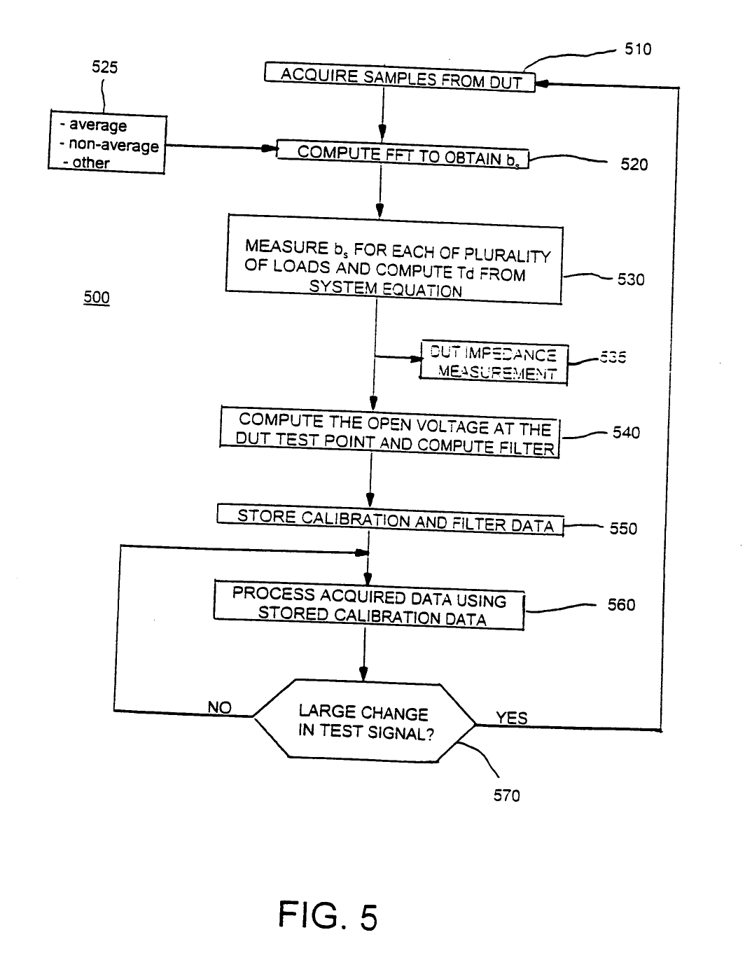

The probe normalization fixture may be a stand alone unit or incorporated within the probe 110. Generally speaking, the probe normalization fixture 300 comprises a set of input probe pins adapted for connection to the DUT and a set of output probe pins adapted for connection to the probe 110. In the case of the probe normalization fixture 300 being included within the probe 110, an electronic or mechanical selection means may be employed within the probe 110 to facilitate inclusion or exclusion of the probe normalization fixture function from the circuit path between the DUT and probe. An embodiment of the probe normalization fixture will be discussed in further detail below with respect to FIG. 5.

The S/T parameter memory 320 may comprise a non-volatile memory where S- or T-parameters for fixture loads are stored. These S- or T-parameters may be provided to an oscilloscope or computer via the communications link COMM such that additional processing may be performed within the signal analysis device. In one embodiment, the probe normalization fixture 300 has associated with it a plurality of probe tips adapted for use by, for example, different devices under test, different testing programs and the like (e.g., current probes, voltage probes, high-power probes and the like). Each of these probe tips may be characterized by respective T-parameters or S-parameters, which T-parameters or S-parameters may be stored in the memory 320 of the probe normalization fixture 300. In one embodiment, the communications link/controller 310 detects the type of probe tip attached and responsively adapts the T- or S-parameters within the memory 320. Thus, the T-parameters or S-parameters associated with specific probe tips of the normalization fixture may be included within the set of equations describing the testing circuit. The T-parameters or S-parameters associated with one or more probe tips may be stored in memory within the probe, the probe tip, the oscilloscope or the fixture.

FIG. 4 depicts an exemplary two-port model and corresponding equations of a probe normalization test channel in which a plurality of elements within the test and measurement system are modeled as a series connection of T-parameter 2-port networks. Specifically, the model 400 (and corresponding equations 400EQ) of FIG. 4 comprises a device under test 2-port network 410 (denoted as Td), a fixture 2-port network 420 (denoted as Tf), a probe 2-port network 430 (denoted as Tp) and a scope 2-port network 440 (denoted as Ts). The DUT 2-port network 410 is depicted as including a DUT network 412 (Td) and a user model 414 (denoted as Tu).

The user model 2-port network 414 (Tu) is optionally provided and gives a T-parameter model for part of the hardware of a device under test. For example, the user model 414 may be used to represent the operating characteristics of a portion of a DUT between an accessible portion (i.e., where probes are operably coupled) to a desired test portion that is normally inaccessible within the DUT (i.e., a portion on the edge of or within a die). The user model accommodates this by letting the user load the S-parameter model (or T-parameter model) into, for example, the DSO, where it becomes part of the calibration process. For example, if the user knows the S-parameters for a bond wire connection from an IC pin to a die chip, then the T-parameter model of the connection may be included in the calculations as the Tu matrix. After system calibration, a probe of the IC pin will result in a waveform representing the die chip signal level.

In general, the invention operates to obtain a frequency domain result by using an FFT transform of the measured incident signal, bₛ, for each calibration load in the fixture. After the final vₒₚₑₙ is computed the result is transformed back to the time domain by using an IFFT. In one embodiment, a filter is employed to implement the FFT and/or IFFT operations which is computed as a result of the calibration process and applied to the time domain data to perform the de-embedding operation.

For illustrative purposes, several assumptions will be made. For initial derivations, the DUT 2-port model will be assumed to have input incidence signal of “a” and a reflected signal of “b”, where “a” and “b” are normalized such that a+b=1. The Td, user DUT, will have internal signal and this results in what will be called the normalized Td parameters. It is assumed the measurement system will be modeled as a series of S-parameter two port networks, which will be converted to T-, transfer, parameters for ease of matrix solutions. These two port networks represent the user's circuit under test and are ordered (per FIG. 4 and equation 3) left to right as DUT, User DUT Model, Fixture, Probe, and Oscilloscope.

In order to simplify the measurement equations it will be assumed that the frequency response of the scope and it's input connector is flat enough. It will also be assumed that the input voltage to port model Td is a+b, and that a+b is a constant voltage source internal to the Td circuit at it's input port. It will also be assumed that scope input and connector provides a relatively flat 50 ohm impedance match over the relevant bandwidth. However, other versions of the measurement may also take into account the parameters of the scope response. This does not preclude the possibility that the scope T-parameters would also be included in the normalization. It is also possible that an assumption of aₛ equal zero at the two-port output of the S-parameter model for the scope might be made.

$$( \begin{matrix}b \\ a\end{matrix} ) = ( \begin{matrix}{Td}_{11} & {Td}_{12} \\ {Td}_{21} & {Td}_{22}\end{matrix} ) \cdot ( \begin{matrix}{Tu}_{11} & {Tu}_{12} \\ {Tu}_{21} & {Tu}_{22}\end{matrix} ) \cdot ( \begin{matrix}{Tf}_{11} & {Tf}_{12} \\ {Tf}_{21} & {Tf}_{22}\end{matrix} ) \cdot ( \begin{matrix}{Tp}_{11} & {Tp}_{12} \\ {Tp}_{21} & {Tp}_{22}\end{matrix} ) \cdot ( \begin{matrix}{Ts}_{11} & {Ts}_{12} \\ {Ts}_{21} & {Ts}_{22}\end{matrix} ) \cdot ( \begin{matrix}{a}_{s} \\ {b}_{s}\end{matrix} ) \qquad Equation 3$$

Where:
Td is the transfer parameters of the DUT;
Tu is a user model of part of circuit under test;
Tf is the transfer parameters of the probe test fixture;
Ts is the transfer parameters of the oscilloscope;
Tp is the transfer parameters of the probe;
bₛ is the voltage measured at the DSO output; and
aₛ is the reflected voltage at the DSO output (assumed to be zero for this derivation, though other derivations and implementation may include it).

Considering the assumptions that a+b=1 and aₛ=0, EQ 3 can be re-written as follows:

$$( \begin{matrix}1 & 1\end{matrix} ) ( \begin{matrix}b \\ a\end{matrix} ) = ( \begin{matrix}1 & 1\end{matrix} ) ( \begin{matrix}{Td}_{11} & {Td}_{12} \\ {Td}_{21} & {Td}_{22}\end{matrix} ) \cdot ( \begin{matrix}{Tu}_{11} & {Tu}_{12} \\ {Tu}_{21} & {Tu}_{22}\end{matrix} ) \cdot ( \begin{matrix}{Tf}_{11} & {Tf}_{12} \\ {Tf}_{21} & {Tf}_{22}\end{matrix} ) \cdot ( \begin{matrix}{Tp}_{11} & {Tp}_{12} \\ {Tp}_{21} & {Tp}_{22}\end{matrix} ) \cdot ( \begin{matrix}{Ts}_{11} & {Ts}_{12} \\ {Ts}_{21} & {Ts}_{22}\end{matrix} ) \cdot ( \begin{matrix}0 \\ {b}_{s}\end{matrix} ) \qquad Equation 3 A$$

such that:

$$\begin{matrix}1 = a + b = ( \begin{matrix}{Td}_{1} & {Td}_{2}\end{matrix} ) \cdot ( \begin{matrix}{Tu}_{11} & {Tu}_{12} \\ {Tu}_{21} & {Tu}_{22}\end{matrix} ) \cdot ( \begin{matrix}{Tf}_{11} & {Tf}_{12} \\ {Tf}_{21} & {Tf}_{22}\end{matrix} ) \cdot ( \begin{matrix}{Tp}_{11} & {Tp}_{12} \\ {Tp}_{21} & {Tp}_{22}\end{matrix} ) \cdot ( \begin{matrix}{Ts}_{11} & {Ts}_{12} \\ {Ts}_{21} & {Ts}_{22}\end{matrix} ) \cdot ( \begin{matrix}0 \\ {b}_{s}\end{matrix} ) \\ where : & Equation 3 B \\ \begin{matrix}{Td}_{1} = {Td}_{11} + {Td}_{21} \\ {Td}_{2} = {Td}_{12} + {Td}_{22}\end{matrix} & ( EQ 3 C )\end{matrix}$$

It should be noted that a different set of Tf for each of the loads switched onto the DUT. The values of Tf, and Tp are measured at time of manufacture and stored in the probe and fixture respectively. The values of Td are computed by making a measurement of bₛ with each of the loads of Tf and then solving the appropriate set of equations. The test setup requires that test fixture connect to the DUT and that probe connects into test fixture.

FIG. 5 depicts a flow diagram of a method for generating the S- or T-parameters of the DUT and a equalization filter for representing an open voltage at the probe test point. The method 500 of FIG. 5 is suitable for use in, for example, the system 100 of FIG. 1. The method utilizes the two port model discussed above and assumes that the test signal provided by the DUT is a relatively steady-state signal (i.e., relatively stable or repeating spectral and/or time domain energy distribution). The equations discussed herein with respect to FIG. 5 (and other figures) depict a plurality of two-port representations including device under test, user, normalization fixture, probe and/or scope T-parameters. The invention may be practiced using only the device parameters Td, fixture parameters Tf and probe parameters Tp where method and apparatus according to the invention are adapted for compensating for the loading imparted to a device under test by a probe. The addition of the scope T-parameters Ts and/or user parameters Tu may be employed in various embodiments. Thus, equations provided herein may be utilized without the user (Tu) and/or scope (Ts) parameters.

The method 500 is entered at step 510 where time domain samples of the signal under test are acquired from the DUT. At step 520, a Fast Fourier Transform (FFT) is computed to obtain the obtain bₛ. Referring to box 525, the computation may be performed using averaged or non-averaged data.

At step 530, bₛ is measured and Td is computed for each of a plurality of load selections (within the normalization fixture). Td is computed using (for the exemplary embodiment), the following equations:

$$\begin{matrix}1 = ( \begin{matrix}{Td}_{1} & {Td}_{2}\end{matrix} ) \cdot ( \begin{matrix}{Tu}_{11} & {Tu}_{12} \\ {Tu}_{21} & {Tu}_{22}\end{matrix} ) \cdot ( \begin{matrix}Tf {1}_{11} & Tf {1}_{12} \\ Tf {1}_{21} & Tf {1}_{22}\end{matrix} ) \cdot ( \begin{matrix}{Tp}_{11} & {Tp}_{12} \\ {Tp}_{21} & {Tp}_{22}\end{matrix} ) \cdot ( \begin{matrix}{Ts}_{11} & {Ts}_{12} \\ {Ts}_{21} & {Ts}_{22}\end{matrix} ) \cdot ( \begin{matrix}0 \\ {b}_{s}\end{matrix} ) & Equation 4 \\ 1 = ( \begin{matrix}{Td}_{1} & {Td}_{2}\end{matrix} ) \cdot ( \begin{matrix}{Tu}_{11} & {Tu}_{12} \\ {Tu}_{21} & {Tu}_{22}\end{matrix} ) \cdot ( \begin{matrix}Tf {2}_{11} & Tf {2}_{12} \\ Tf {2}_{21} & Tf {2}_{22}\end{matrix} ) \cdot ( \begin{matrix}{Tp}_{11} & {Tp}_{12} \\ {Tp}_{21} & {Tp}_{22}\end{matrix} ) \cdot ( \begin{matrix}{Ts}_{11} & {Ts}_{12} \\ {Ts}_{21} & {Ts}_{22}\end{matrix} ) \cdot ( \begin{matrix}0 \\ {b}_{2 s}\end{matrix} ) & Equation 5 \\ 1 = ( \begin{matrix}{Td}_{1} & {Td}_{2}\end{matrix} ) \cdot ( \begin{matrix}{Tu}_{11} & {Tu}_{12} \\ {Tu}_{21} & {Tu}_{22}\end{matrix} ) \cdot ( \begin{matrix}Tf {3}_{11} & Tf {3}_{12} \\ Tf {3}_{21} & Tf {3}_{22}\end{matrix} ) \cdot ( \begin{matrix}{Tp}_{11} & {Tp}_{12} \\ {Tp}_{21} & {Tp}_{22}\end{matrix} ) \cdot ( \begin{matrix}{Ts}_{11} & {Ts}_{12} \\ {Ts}_{21} & {Ts}_{22}\end{matrix} ) \cdot ( \begin{matrix}0 \\ {b}_{3 s}\end{matrix} ) & Equation 6\end{matrix}$$

To solve for the variables Td₁ and Td₂, two equations obtained from measurements with two different loads are sufficient. However, the inventors note that multiple equations from multiple measurements using different loads can improve the accuracy of Td₁ and Td₂ values by, for example, simple averaging or minimum least square error methods. Once the variables Td₁ and Td₂ are solved, the impedance of the DUT may be determined as a function of frequency to be discussed in greater detail below.

At step 540, the open voltage at the DUT probe point is calculated by replacing the two-port network with a two-port representation of an open circuit, as follows:

$$1 = ( \begin{matrix}{Td}_{1} & {Td}_{2}\end{matrix} ) \cdot ( \begin{matrix}1 & 0 \\ 0 & 1\end{matrix} ) \cdot ( \begin{matrix}{a}_{0} \\ {b}_{0}\end{matrix} ) \qquad ( EQ 7 )$$

The inventors note that the open circuit voltage vₒₚₑₙ is actually twice the value of aₒ since in the open circuit case aₒ=bₒ and vₒₚₑₙ=aₒ+bₒ, such that:

$${v}_{open} = 2 {a}_{0} = \frac{2}{{Td}_{1} + {Td}_{2}} \qquad ( EQ 8 )$$

In one embodiment of the invention, at step 540 the equations are derived from the above measurements to realize a frequency domain filter response. The frequency domain response of the filter can be derived from its transfer function. The filter transfer function is as follows:

$$\begin{matrix}H = \frac{{v}_{open}}{{b}_{is}} \\ such that \text{:} & ( EQ 9 ) \\ {\hat{v}}_{open} = H \cdot {\hat{b}}_{s} & ( EQ 10 )\end{matrix}$$

where bᵢₛ is the scope measurement i-th load during calibration procedure, and \hat{b}ₛ is the scope measurement with the same i-th load during testing procedure.

The above response is multiplied with an FFT of each new time domain acquisition with the probe at a test point to provide thereby a de-embedded response at the DUT test point. Thus, the T-parameters for the DUT (and, optionally, corresponding parameters for the normalization fixture, probe and/or scope) are determined such that a response filter based upon the various parameters with the normalization fixture removed may be determined. This filter is applied after the normalization fixture is removed from the circuit and the scope probe is connected to the same point in the DUT where the fixture calibration process was performed. In this manner, the normalization fixture is used to characterize the loading of the system upon the device under test and such that a response filter may be provided wherein such device loading is compensated for. Alternatively, the fixture may be left in place without perturbing the physical positions for better de-embed accuracy. The filter is applied to the FFT of the acquired signal. An inverse FFT of \hat{v}ₒₚₑₙ yields the time domain version of this signal.

In a further embodiment of the invention, the frequency domain equalization filter H is converted to a time domain equalization filter using well known transformation techniques, such as an inverse FFT, inverse DFT and the like. The time domain equalization filter is convolved with each new time domain acquisition with the probe at a test point to provide thereby a de-embedded response at the DUT test point. At step 550, the calibration data and, optionally, filter data is stored in, for example, the data portion 259D of the memory 258. It is noted that in the above solution (EQ 8), the term aₒ represents the voltage in the DUT probe point with substantially all effects of probing de-embedded. This is the desired result of the calibration process. As a practical matter, it is noted that the physical movement of a probe (especially a non-differential probe) will slightly perturb the characteristics and, therefor, a new calibration might be desired. Alternatively, the fixture may be left in place without perturbing the physical positions for better de-embed accuracy.

At steps 560 and 570 the method operates to repeatedly process acquired data using the stored calibration data to provide de-embedded data for generating waveforms, providing test data to remote devices and the like. Upon detecting (at step 570) a relatively large change in the test signal, the method proceeds to step 510. For example, in one embodiment of the invention, during calibration the changes in measured voltages as a function of frequency for various loads connected is noted by the controlling device (e.g., a DSO). The controlling device then chooses only those loads that give minimal change in DUT voltage while still providing enough change to have a reasonable signal to noise ratio for the de-embed computations.

In one embodiment of the invention, once calibration has been performed and the DUT signal is being observed with de-embedding, the user is alerted if a major difference in the signal occurs in terms of signal level or waveshape. In an alternate embodiment, another calibration is performed for this case so that the user can make determinations of circuit linearity based on signal level. For example if the DUT signal was calibrated with one level and then changed to another amplitude level then the user measures the new level with the current calibration. Then the user optionally performs a new calibration and measure this signal again. If the measured results are different between the two calibrations then that would be an indication of non-linear DUT behavior at different signal levels.

In still another embodiment, where the user knows the S- or T-parameters of a particular test point, those test parameters are loaded into the testing or controlling device via, for example, the above-described menu structure. In this embodiment, there is no need to connect the de-embed fixture, and the probe is directly connected to the test point.

New data bₛ is acquired and now the values of aᵢₙ and bᵢₙ are computed as shown in the following equation:

$$( \begin{matrix}{b}_{i n} \\ {a}_{i n}\end{matrix} ) = ( \begin{matrix}{Td}_{11} & {Td}_{12} \\ {Td}_{21} & {Td}_{22}\end{matrix} ) \cdot ( \begin{matrix}{Tu}_{11} & {Tu}_{12} \\ {Tu}_{21} & {Tu}_{22}\end{matrix} ) \cdot ( \begin{matrix}{Tp}_{11} & {Tp}_{12} \\ {Tp}_{21} & {Tp}_{22}\end{matrix} ) \cdot ( \begin{matrix}{Ts}_{11} & {Ts}_{12} \\ {Ts}_{21} & {Ts}_{22}\end{matrix} ) \cdot ( \begin{matrix}0 \\ {b}_{s}\end{matrix} ) \qquad ( EQ 11 )$$

Once aᵢₙ and bᵢₙ are known, then the probe two-port matrix can be replaced with an open circuit two-port representation, identity matrix, and the DUT test point voltage can computed as 2aₒₚₑₙ, as follows:

$$( \begin{matrix}{b}_{i n} \\ {a}_{i n}\end{matrix} ) = ( \begin{matrix}{Td}_{11} & {Td}_{12} \\ {Td}_{21} & {Td}_{22}\end{matrix} ) \cdot ( \begin{matrix}1 & 0 \\ 0 & 1\end{matrix} ) \cdot ( \begin{matrix}{a}_{open} \\ {b}_{open}\end{matrix} ) \qquad ( EQ 12 )$$

As previously noted, an IFFT of aₒₚₑₙ is computed to obtain the time domain version of the signal under test.

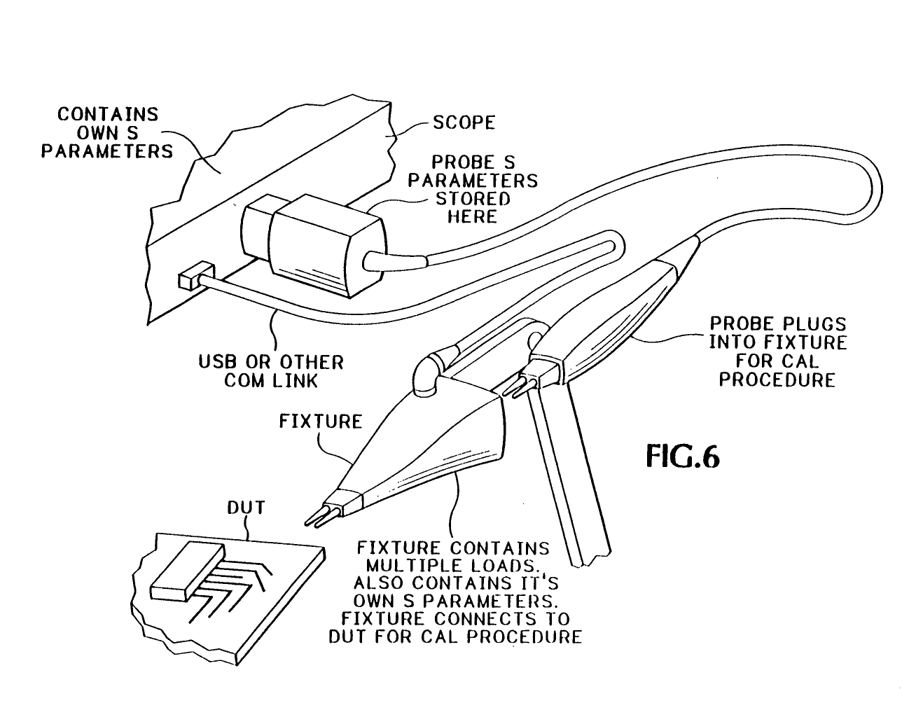

FIG. 6 illustrates one embodiment of the present invention. Specifically, FIG. 6 graphically illustrates an embodiment of the invention wherein a scope (optionally storing S-parameters and/or T-parameters) is operatively coupled to a probe. The probe optionally stores S-parameters and/or T-parameters in, for example, a non-volatile memory within the probe connector housing. A normalization fixture containing multiple loads and/or an impedance matrix such as described above with respect to FIG. 3 is adapted to receive the probe at an input. The normalization fixture is also adapted to receive a communication link from the scope. The normalization fixture optionally stores its own S-parameters and/or T-parameters. The normalization fixture includes a probe tip adapted to electrically probe a device under test, such as described above with respect to the various figures. It should be noted that the separate communication link cable between the normalization fixture and the scope shown in FIG. 6 may be integrated with the probe cable. It should also be noted that the function of the normalization fixture may be included within the probe.

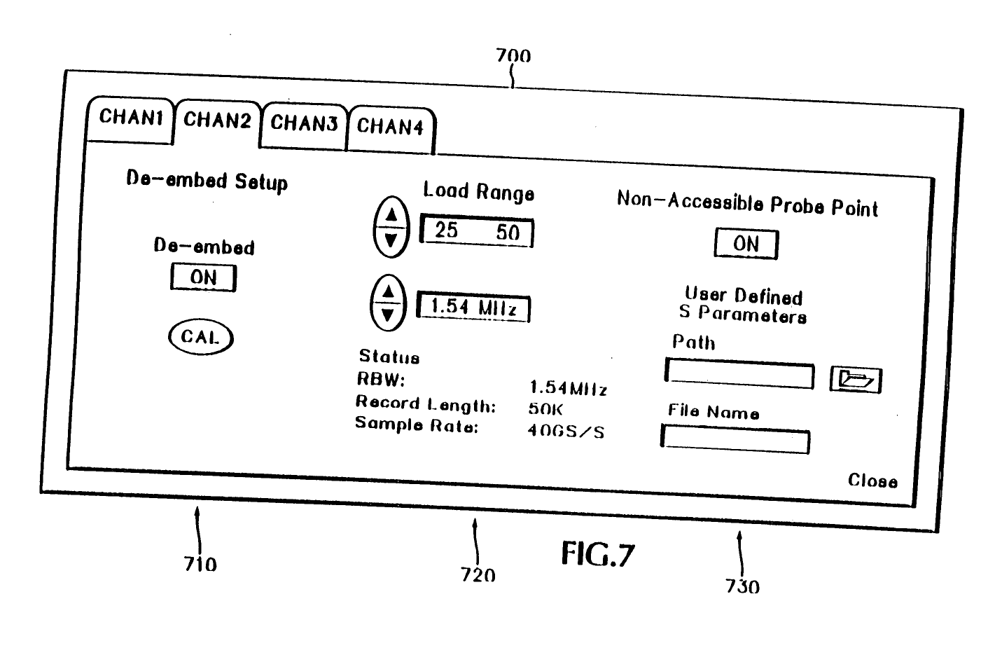

FIG. 7 depicts a user interface screen suitable for use in an embodiment of the present invention. Specifically, FIG. 7 depicts a de-embed set-up menu 700 comprising de-embed selector commands 710, load range commands 720 and non-accessible probe point commands 730. The de-embed set-up menu 700 may be accessed directly or via other menus (not shown) within the menu structure or hierarchy of a digital storage oscilloscope, computer or other test and measurement device.

Referring to the de-embed set-up commands 710, a first button denoted as “ON” is used to enable or disable the de-embed function, while a second button denoted as “CAL” is used to enable calibration of a test system according to the system, method and apparatus discussed above. That is, assuming the de-embed function is enabled, a calibration function is utilized wherein a probe is connected to a normalization fixture, the normalization fixture is connected to a device under test, the calibration button is pressed, and the resulting waveforms are viewed after processing according to, for example, the method described above with respect to FIG. 5.

The load range functions 720 allow user selection of a range of DUT load impedance (illustratively 25-50 ohms) via a first dialog box and a resolution bandwidth (RBW, illustratively 1.54 MHz) via a second dialog box. A status box provides an indication to a user of, illustratively, a bandwidth range, a record length (illustratively 50 KB) and a sample rate (illustratively 40 GS/s). Other information may be included within the status indication box.

Referring to the non-accessible probe point command 730, a first button denoted as “ON” enables the use of user defined S- or T-parameters within the context of the present invention. That is, where a user wishes to incorporate the S- or T-parameters associated with a two-port network mathematically inserted between the DUT and normalization fixture two-port networks (or other location), those S- or T-parameters are provided by the user as a file. Thus, the non-accessible probe point commands include a path dialog box enabling the user to identify where within the mass storage structure of the DSO the files are located, and a file name dialog box indicating the name of the user supplied S- or T-parameter file.

Once the initial measurements have been made and the characterizing equations determined for the T- or S-parameters of the DUT as represented in steps 510 through 530 in FIG. 5, a computation may be made to determine the impedance of the DUT as a function of frequency as represented in step 535. The transfer parameters Td₁ and Td₂ for each of the selected impedance loads are characterized in the spectral domain as a function of frequency to produce impedance values Z_{eq} as a function of frequency. The reference impedance Z_{ref} is associated with both the T- or S-parameters of the test and measurement system and the characteristic impedance of the DSO 200. Referring back to FIG. 4, the reflected voltage aₛ at the DSO 200 output is assumed to be zero which indicates that the impedance of the load Z_{L} is equal to the reference impedance of the transfer parameters Ts of the DSO 200 in the test and measurement system. In the preferred embodiment, the T- or S-parameters for the elements of the test and measurement system are preferably characterized in a 50 ohm impedance environment and the impedance Z_{L} of the DSO 200 is 50 ohms.

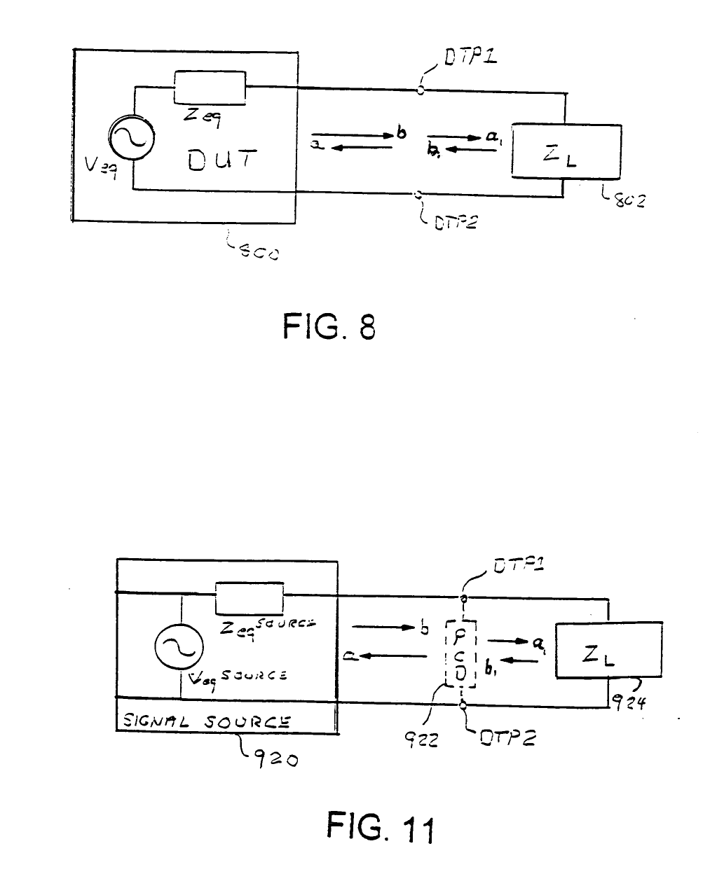

For an understanding of the present invention, it is worthwhile to describe the relationship between voltages with typical impedance loads. FIG. 8 is a representation of a DUT 800 connected to a load (Z_{L}) 802. The voltage out of the DUT 800 into the DUT test points DTP1 and DTP2 is “b” and the reflected voltage from the DUT test points DTP1 and DTP2 to the DUT 800 is “a”. The incident voltage “a₁” from the DUT test points DTP1 and DTP2 and the reflected voltage “b₁” into the DUT test points DTP1 and DPT2 are related to the DUT as:

$$1 = [ \begin{matrix}{Td}_{1} & {Td}_{2}\end{matrix} ] \cdot [ \begin{matrix}{b}_{1} \\ {a}_{1}\end{matrix} ] \qquad ( EQ 13 )$$

where Td₁ and Td₂ are combinations of the T-parameters of the DUT described with relation to the calibration of the probe. When the DUT is connected to the load (Z_{L}) 802, loading can be represented by its reflection coefficient (Γ_{L}) where “a₁” and “b₁” are related by b₁=Γ_{L}·a₁ where the reflection coefficient is the S₁₁ parameter of the load Z_{L}. The reflection coefficient for the load (Z_{L}) 802 may be specified by the user using the equation:

$${Γ}_{L} = \frac{{Z}_{L} - {Z}_{ref}}{{Z}_{L} + {Z}_{ref}} \qquad ( EQ 14 )$$

where Z_{ref} is known and Z_{L} is the impedance of the load. In the preferred embodiment of the invention, Z_{ref} is the characteristic impedance of the measurement system which is generally 50 ohms but other impedance values may be used without departing from the scope of the present invention.

The total voltage V_{L} at the test points DTP1 and DTP2 is the sum of the incident voltage and the reflected voltage as shown by the following equation.
V_{L}=a₁+b₁ (EQ 15)
The voltage at the test points DTP1 and DTP2 with a load can be derived from the previous equations and written as follows:

$${V}_{L} = \frac{{Γ}_{L} + 1}{{Γ}_{L} {Td}_{1} + {Td}_{2}} \qquad ( EQ 16 )$$

For an “open” load where the reflection coefficient (Γ_{L})=1 equation 16 yields the following results:

$${V}_{open} = \frac{2}{{Tb}_{1} + {Tb}_{2}} \qquad ( EQ 17 )$$

For a “shorted” load, where the reflection coefficient (Γ_{L})=−1 yields a voltage value of zero. For a load Z_{L} equal to the measurement system reference impedance Z_{ref} of 50 ohms, the reflection coefficient (Γ_{L}) would be 0 where equation 16 would yield:

$${V}_{Zref} = \frac{1}{{Td}_{2}} \qquad ( EQ 18 )$$

where V_{Zref} is the voltage at the test points DTP1 and DTP2 terminated by the reference impedance.

The DUT 800 can be reduced to a Thevenin equivalent circuit consisting of a single voltage source V_{eq} and impedance Z_{eq}. The DUT 800 can also be represented by the variables Td₁ and Td₂ which are obtained from the probe de-embed procedure. The relationship between these two sets of variables provides a means to measure the impedance of the DUT 800 using Td₁ and Td₂.

When the DUT 800 is terminated by an “open”, equation 17 gives the voltage value at the test points DTP1 and DTP2. From the Thevenin equivalent circuit, the Vₒₚₑₙ voltage is equal to the voltage V_{eq} of the Thevenin voltage source as shown by the following equation:

$${V}_{eq} = {V}_{open} = \frac{2}{{Td}_{1} + {Td}_{2}} \qquad ( EQ 19 )$$

When the DUT 800 is terminated by the reference impedance Z_{ref}, which is defined as the characteristic impedance of the probe measurement system, generally 50 ohms, equation 18 gives the voltage value at the test points DTP1 and DTP2. It can be obtained from the Thevenin equivalent circuit that

$${V}_{Zref} = \frac{{Z}_{ref}}{{Z}_{ref} + {Z}_{eq}} {V}_{eq} \qquad ( EQ 20 )$$

Combining equation 18 and equation 19 into equation 20 yields:

$$\frac{1}{{Td}_{2}} = \frac{{Z}_{ref}}{{Z}_{ref} + {Z}_{eq}} \cdot \frac{2}{{Td}_{1} + {Td}_{2}} \qquad ( EQ 21 )$$

Z_{eq} can be solved from equation 21 as follows:

$${Z}_{eq} = ( \frac{2 {Tb}_{2}}{{Tb}_{1} + {Tb}_{2}} - 1 ) \cdot {Z}_{ref} \qquad ( EQ 22 )$$

Equation 22 gives the solution for the impedance measurement of the DUT 800 with a signal source inside the DUT 800.

FIG. 9 represents a flow diagram of the method for generating a representation of the impedance of the DUT 800 from the DUT transfer parameters. The de-embed probe 110 is coupled to the test points DTP1 and DTP2 and time domain samples of the signal under test from the DUT 800 are acquired with selectable impedance loads coupled into the signal path of the DUT 800. For each of the selected impedance loads, the FFT is computed on the acquired time domain samples and the transfer parameters Td₁ and Td₂ are characterized as a function of the frequency as represented by steps 505 though 530 in FIG. 5. As previously stated, the reference impedance Z_{ref} is associated with the impedance environment in which the transfer parameters of the elements in the test and measurement system are characterized. In the preferred embodiment, the reference impedance Z_{ref} is 50 ohms. A value representing the reference impedance Z_{ref} is stored in and retrieved from the memory 259D of the signal analysis device as represented in step 900.

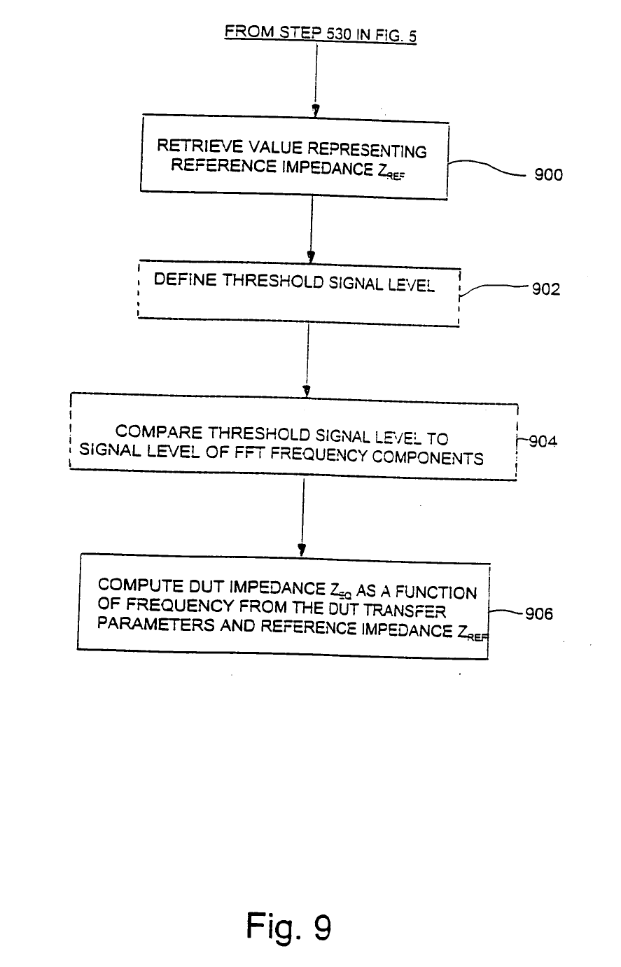

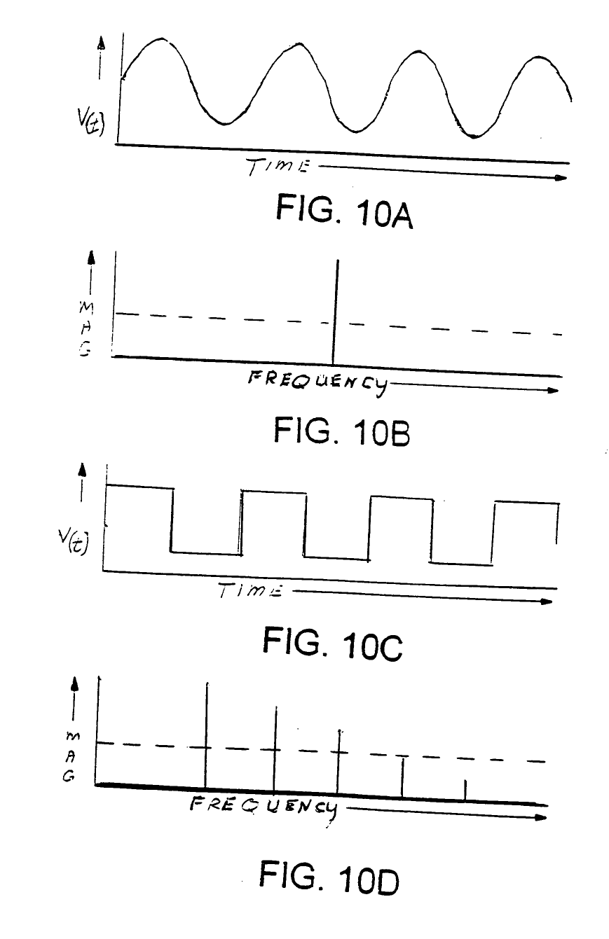

A signal threshold level is preferably defined as recited in step 902. The signal threshold level is compared to the signal level of the frequency components of the FFT spectral domain representations of the time domain digital samples acquired for each of the selected impedance loads coupled into the signal path coupled to the DUT 800 as represented in step 904. As shown in FIGS. 10A through 10D, performing a FFT on time domain digital samples results in a spectral domain representation of the frequencies contained in the time domain signal. FIG. 10A represents a pure sine wave signal with the resulting spectral domain representation of the pure sine wave signal being shown in FIG. 10B. The FFT of the pure sine wave signal in the spectral domain generates a single frequency component whose frequency is equal to the frequency of the sine wave signal. FIG. 10C represents a square wave with the resulting spectral domain representation of the square wave being shown in FIG. 10D. The FFT of the square wave signal in the spectral domain generates a fundamental frequency component at the frequency of the square wave and odd harmonic frequency components of the fundamental frequency. Electrical signals generally have distortions caused by noise, jitter and the like. These distortions generate unwanted frequency components in the spectral domain which generally have signal levels substantially lower than the signal levels of the frequency components of the signal. The threshold signal level is used to suppress the unwanted frequency components from the impedance measurement. The impedance Z_{eq} of the DUT 800 is computed as represented by step 906 for those frequency components above the threshold signal level in the frequency domain from the DUT transfer parameters and the reference impedance Z_{ref} as represented by equation 22. While the preferred method includes the threshold signal level and the comparison of the threshold signal level with the signal level of the frequency components of the spectral domain representation of the time domain signal, the invention can be practiced without the signal reference level comparison. In such an implementation, there may be resulting impedance values that may require additional filtering.

The above described impedance measurement is performed on a DUT having a signal source inside the DUT. It is also possible with the present invention to measure the impedance of a passive circuit device (PCD). The DUT then consists of a signal source 920 and the passive circuit device 922 as representatively shown in FIG. 11. In this implementation, the de-embed probe 110, represented by Z_{ref}, is first coupled to the signal source and the impedance Z_{eq}^{source} of the signal source is obtained as previously described for the DUT 800. The signal source 920 is then coupled in parallel with the passive circuit device 922 and the impedance Z_{eq}^{comb} of the combined signal source and the passive circuit device is obtained. The impedance Z_{eq}^{PCD} of the passive circuit device is then computed from the impedance Z_{eq}^{source} of the signal source and the impedance Z_{eq}^{comb} of the combined signal source and the passive circuit device as represented by the following equation:

$${Z}_{eq}^{PCD} = \frac{{Z}_{eq}^{source} \cdot {Z}_{eq}^{comb}}{{Z}_{eq}^{source} - {Z}_{eq}^{comb}} \qquad ( Eq 23 )$$

where the impedances of the signal source 920 and the passive circuit device 922 are from a 1-port network.

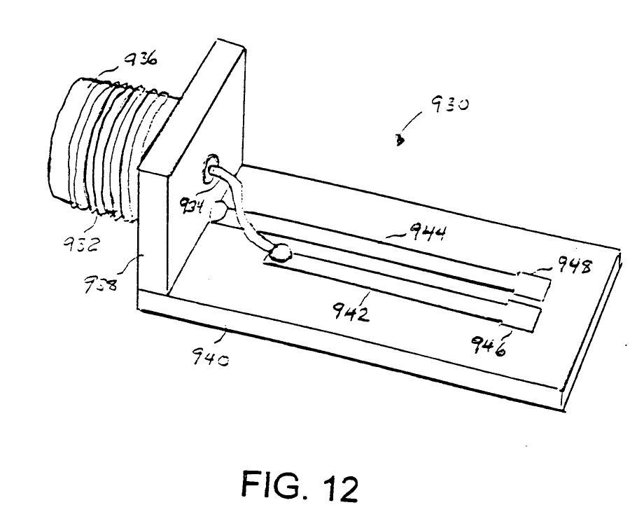

FIG. 12 is an example of a test fixture 930 for computing the impedance of a passive circuit device. The test fixture 930 has an SMA connector 932 having a central signal conductor 934 and an electrically conductive housing 936. The SMA connector 932 is mounted on an electrically conductive vertical member 938 with the electrically conductive housing 936 in electrical contact with the electrically conductive vertical member 938. The vertical member 938 is affixed to a horizontal member 940 having first and second electrically conductive traces 942 and 944 which terminate in first and second electrically conductive contact pads 946 and 948. The central signal conductor 934 of the SMA connector 932 is electrically coupled to one of the electrically conductive traces 942, 944 and the other electrically conductive trace 942, 944 is electrically coupled to the SMA housing 936 via the electrically conductive vertical member 938. The signal source 920 is coupled via a cable to a SMA connector 932 on the test fixture 930. The passive circuit device 922 is electrically coupled to the electrically conductive contact pads 946 and 948. The electrically conductive contact pads are equivalent to the test points DTP1 and DTP2 in FIG. 11. It should be noted in the below description for computing the impedance of a passive circuit device that the S- or T-parameters of the test fixture 930 may be incorporated in the impedance measurement. The S- or T-parameters of the test fixture 930 may be computed and stored as file in the signal analysis device 200 and provided to the impedance measurement computation.

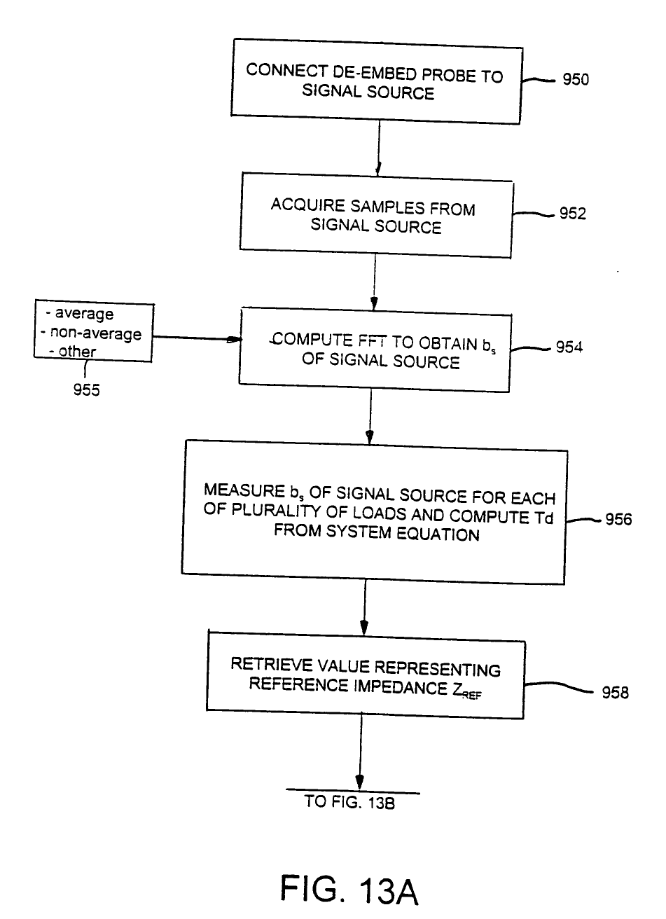

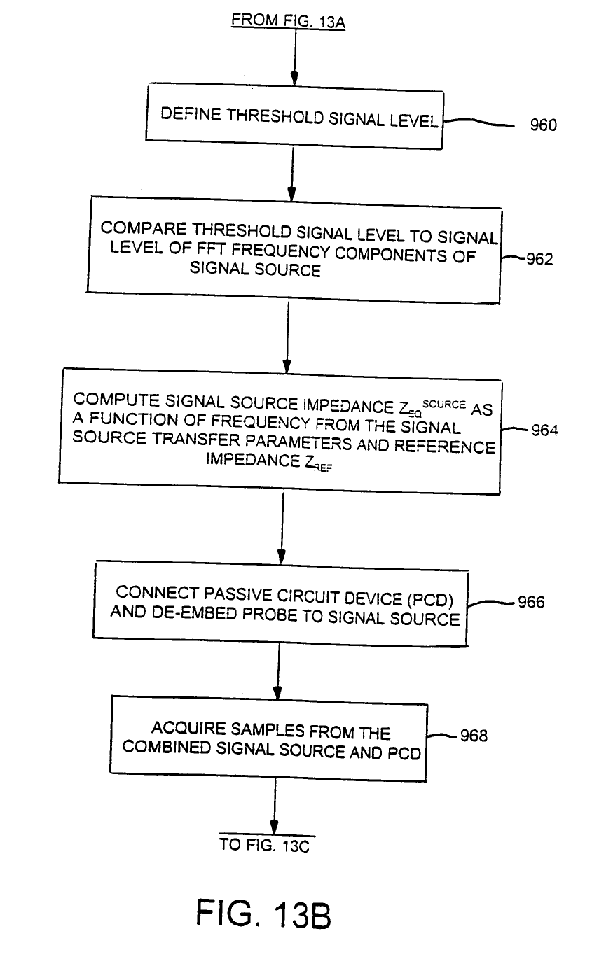

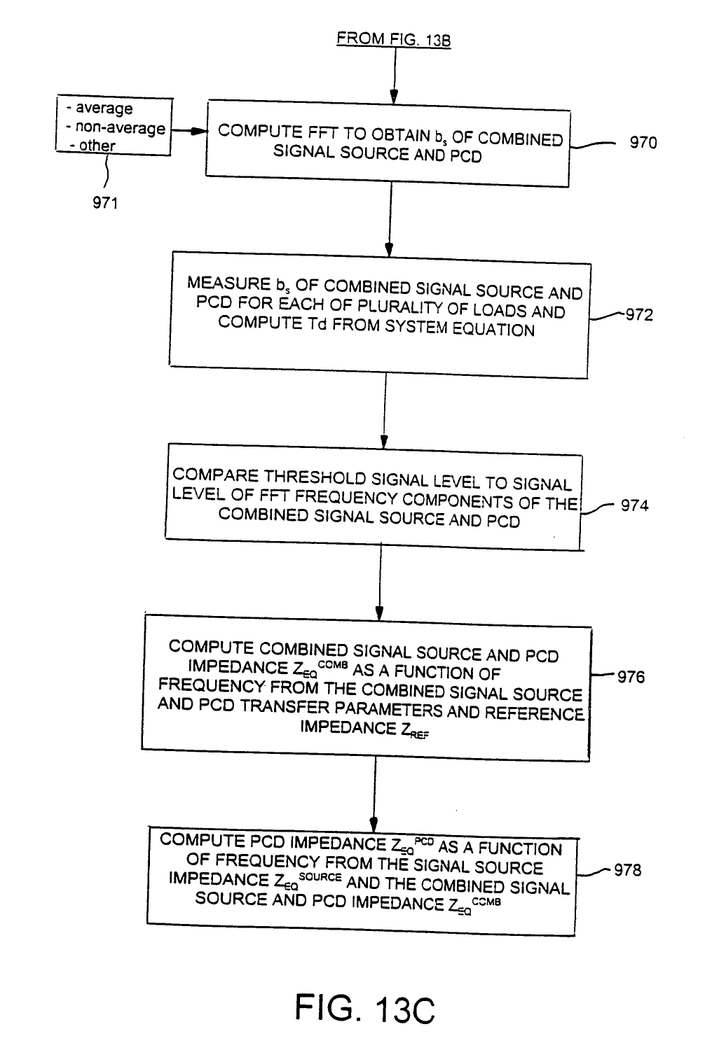

FIGS. 13A through 13C are a flow diagram of the method for generating a representation of the impedance of the passive circuit device 922 from the impedance of the signal source 920 and the combined impedance of the signal source and the passive circuit device 922. At step 949, the a trigger signal is coupled from the signal source 920 to the signal analysis system (DSO) 200. At step 950, the de-embed probe 100 is connected to the signal source 920 via the SMA connector 932 and the electrically conductive contact pads 946 and 948 on the test fixture 930. At step 952, the signal analysis device 200 acquires time domain samples of the signal from the signal source 920 with selected impedance loads coupled into the signal path of the signal source 920. For each selected impedance load, the FFT of the time domain samples is computed to obtain bₛ as represented in step 954. The computation may be performed using averaged or non-averaged data as represented in step 955. At step 956, the transfer parameters of the signal source 920 is computed from the system equations for each of the selected impedance. At step 958, the value representing the reference impedance Z_{ref} is retrieved from memory 259D. A threshold signal level is defined for comparison with the signal levels of the frequency components of the spectral domain representation of the time domain samples computed from the FFT of the time domain samples as represented in step 960. At step 962, the threshold signal level is compared to the signal level or levels of the FFT frequency components of the signal source 920. At step 964, the signal source impedance Z_{eq}^{source} is computed as a function of frequency from the signal source transfer parameters and the value representing the reference impedance Z_{ref} for those frequency components above the threshold signal level.

At step 966 the passive circuit device 922 is connected to the electrically conductive contact pads 946 and 948 of the test fixture 930 along with the de-embed probe 110. At step 968, the signal analysis device 200 acquires time domain samples of the signal under test from the combined signal source 920 and passive circuit device 922 with selected impedance loads coupled into the signal path of the combined signal source 920 and passive circuit device 922. For each selected impedance load, the FFT of the time domain samples is computed to obtain bₛ as represented in step 968. The computation may be performed using averaged or non-averaged data as represented in step 971. At step 972, the transfer parameters of the combined signal source 920 and passive circuit device 922 are computed from the system equations for each of the selected impedance loads. At step 974, the threshold signal level is compared to the signal level or levels of the FFT frequency components of the combined signal source 920 and passive circuit device 922. At step 976, the combined signal source and passive circuit device impedance Z_{eq}^{comb} is computed as a function of frequency from the combined signal source and passive circuit device transfer parameters and the reference impedance Z_{ref} for those frequency components above the threshold signal level. At step 978, the passive circuit device impedance Z_{eq}^{PCD} is computed as a function of frequency from the signal source impedance Z_{eq}^{source} and the combined signal source and passive circuit device impedance Z_{eq}^{comb}.

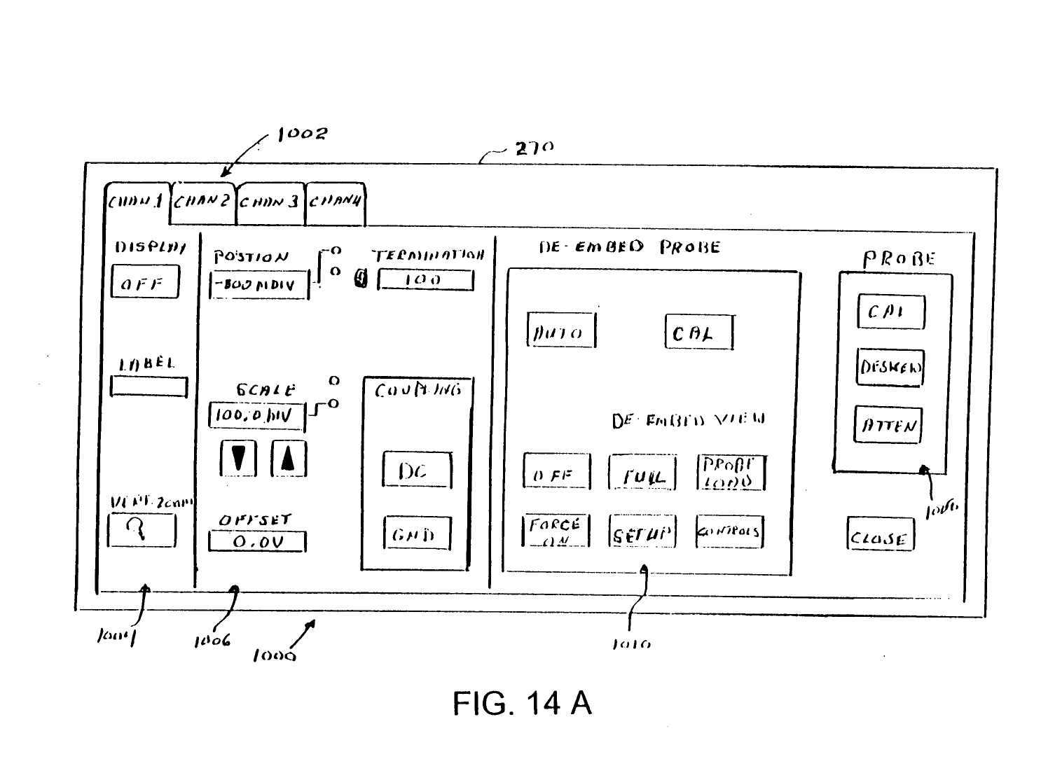

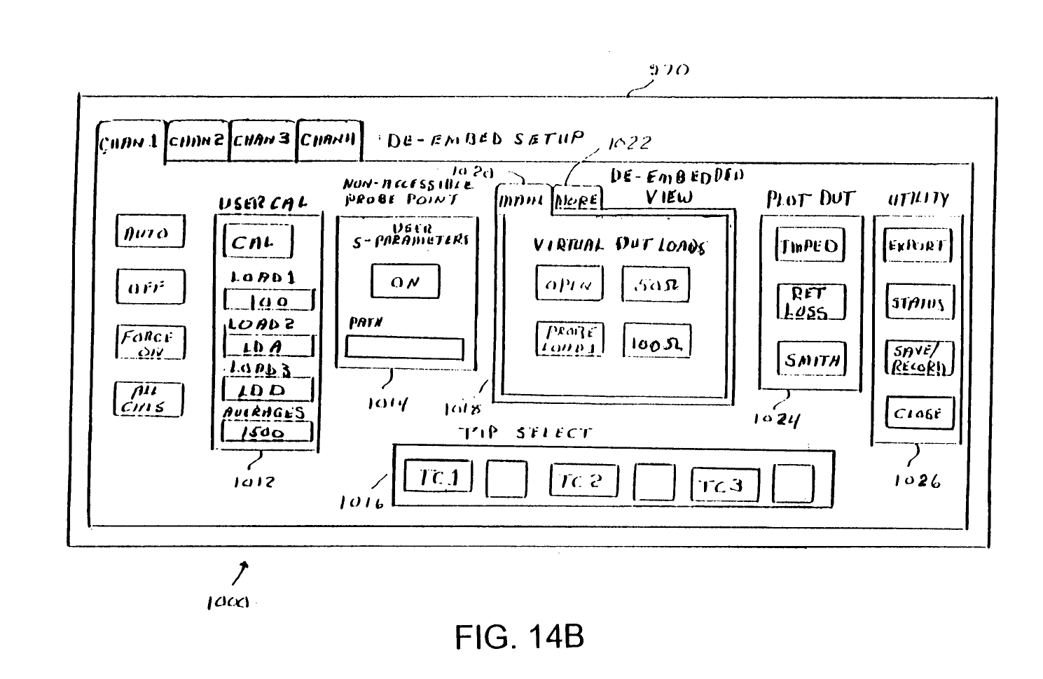

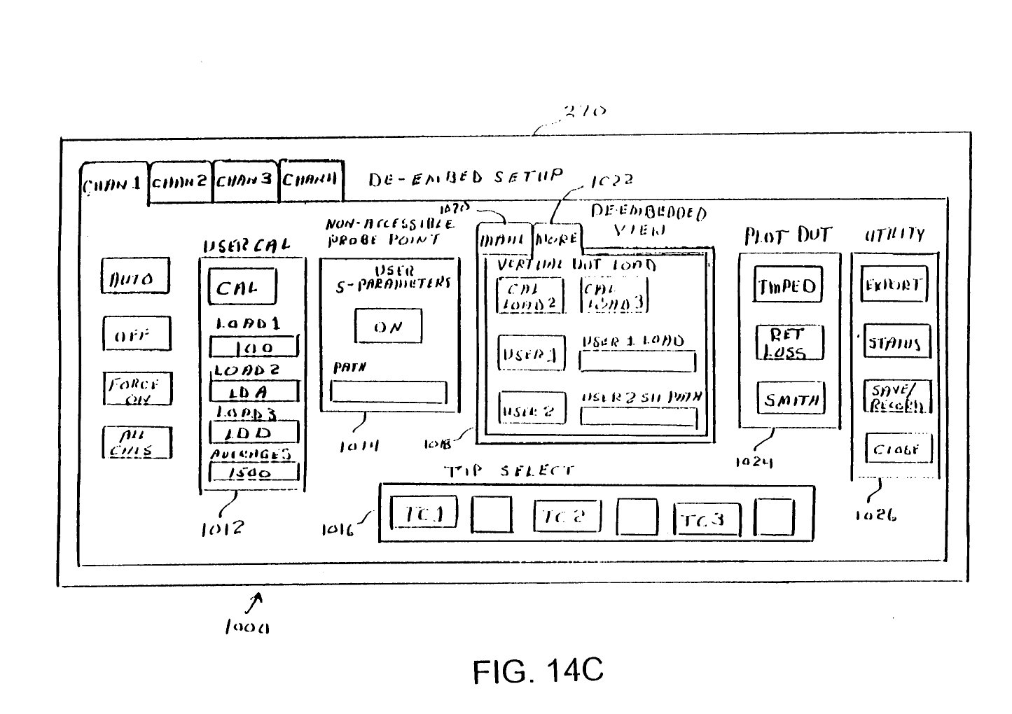

FIG. 14A illustrates an example of a user interface 1000 for implementing the impedance measurement testing system and method of the present invention. The user interface 1000 may be implemented as part of the vertical menu on a TDS6804B Digital Phosphor Oscilloscope, manufactured and sold by Tektronix, Inc. Beaverton, Oreg. The user interface 1000 is displayed on the display device 270 under control of the controller 250. The user interface has channel tabs 1002 for each of th respective channels of the oscilloscope 200. The controller 250 detects the presence of probe capable of being de-embedded and configures the user interface 1000 accordingly. The user interface 1000 is divided into sections with section 1004 related to display parameters and section 1006 related to the channel conditioning parameters. Section 1008 relates to selectable probe procedures, such as a standard probe calibration procedure, a procedure for deskewing multiple probes coupled to the oscilloscope, and a procedure for setting the probe attenuation. Section 1010 relates to the parameters and procedures for de-embedding the probe.

The CAL menu button is pressed by the user after the probe has been connected to the DUT 800. A pop-up dialog box having FINISH and CANCEL button may be included to prompt the user to make sure the probe is connected to the DUT 800. The calibration process applies de-embed loads to the DUT 800 test points DTP1 and DTP2 and calculates the combination of S- or T-parameters Td₁ and Td₂ of the DUT 800. The AUTO button turns on the de-embed filter operations, such as full de-embed and the arbitrary load testing, as long as the scope parameters allows it. The OFF button turns off the de-embed filter operation resulting in the acquired samples having errors due to the probe loading and through response and due to the oscilloscope response. Various parameter settings for the oscilloscope may cause the filter not to run. The FORCE ON button addresses this issue by changing the oscilloscope parameter settings to allow the de-embed filter to run. The FULL de-embed view configures the filter operation to process the acquired samples as if the DUT 800 is coupled to an open load. The PROBE LOAD de-embed view configures the filter operation to process the acquired samples as if the DUT 800 is coupled to a probe having its associated impedance. The SETUP button brings up a display of a de-embed setup menu that contains additional controls for configuring the de-embed probe

FIG. 14B illustrates an example of a de-embed setup menu. On the left side of the display are the AUTO, OFF and FORCE on buttons previously described. The all channels ALL CHLS button when activated will force the AUTO/OFF/FORCE ON functions to occur on all channels that have a de-embed probe connected. THE USER CAL section 1012 of the display includes the CAL button previously described and fields for defining the de-embed loads that are to be used when the CAL process is executed. LOAD 1, LOAD2 and LOAD3 allow the user to specify the de-embed cal loads that are used during calibration. Alternately, the system may be configured to automatically set specified de-embed cal loads. The AVERAGES field specifies the number of averages used for the signal acquisitions during the CAL process. The NON-ACCESSIBLE PROBE POINT section 1014 includes an ON/OFF button and a field for entering a path to a two-port S- or T-parameter file defining the characteristics of a portion of the DUT 800 between the probe test points DTP1 and DPT2 and the circuit test points CTP1 and CTP2. With the ON/OFF button on, the two-port S- or T-parameter file is included in the calibration of the probe. The TIP SELECT section 1016 of the display allows a user to specify a particular probing tip that is to be connected to the probe. The oscilloscope has a library of S- or T-parameters for the available probing tips. Type numbers identify the probing tips and the display may include pictures of the tips to allow the user to be sure that the selected tip matches the selected parameters.

The DE-EMBEDDED VIEW section 1018 has a MAIN tab 1020 and a MORE tab 1022. The MAIN tab 1020 displays buttons that activate various virtual DUT loads. The OPEN button activates the de-embed filter that results in a full de-embed (i.e. an equalization filter representing an open load on the DUT). The loading effects of the probe, the through response of the probe and scope are removed from the acquired samples of the DUT signal. The PROBE LOAD 1 button activates a de-embed filter that results in the acquired samples representing the DUT signal with the probe loading the DUT signal. The error due to the probe through response and the oscilloscope response are removed from the acquired samples. The 50Ω and 100Ω buttons respectively activate de-embed filters that results in the acquired samples representing the DUT signal with a 50 ohm load and a 100 ohm load coupled to the DUT. The PLOT DUT section 1024 of the display has buttons that allows the user to activate display plots of the impedance, return loss, and a smith chart of the impedance derived from the acquired samples of the DUT signal. The Utility section 1026 of the display includes an EXPORT button that when activated brings up an export menu dialog box. The dialog box allows a user to specify a file name and export an ASCII file of the processed data from the DUT. The STATUS button activates a view window with information about the relevant parameters associated with the de-embed operation. The SAVE/RECORD button activates a submenu that allows the user to save the current DUT test point calibration data and filter to a file. It includes a field that allows the user to enter a name associated with each DUT test point.

FIG. 14C illustrates an example of the DE-EMBEDDED VIEW section 1018 where the MORE tab 1022 has been activated. The MORE tab 1022 displays buttons that activate additional virtual DUT loads. The CAL LOAD2 and CAL LOAD3 buttons respectively activate de-embed filters that results in the acquired samples representing the DUT signal with the CAL LOAD2 and the CAL LOAD3 loading the DUT signal. The USER1 button and associated field activates a de-embed filter having an arbitrary impedance load defined by the user. The load value may be specified as a single resistance element or a single reactive element or combination of the two. For example, an entry of 75 in the field means 75 ohms resistance. A value of j85 means an inductive reactance of 85 ohms. A value of 35−j77 means a combination of a resistance of 35 ohms and capacitive reactance of 77 ohms. The USER2 button and associated filed activates a de-embed filter having an arbitrary impedance defined by an S- or T-parameter file and path. The S₁₁ parameter or its T-parameter equivalent would be contained in an ASCII format in a file provided by the user. This allows the user to specify a very complex load that varies as a function of frequency.

The present invention is a system and process that characterizes the transfer parameters of a device under test using acquired samples of the signal from a device under test, assigning a reference impedance representing the probe and measurement system coupled to the device under test and processing the transfer parameters and the reference impedance to effect thereby a representation of the device under test impedance as a function of frequency. The present invention further allows the processing of acquired samples from a passive circuit device coupled to a signal source to effect thereby a representation of the passive circuit device impedance as a function of frequency.

While the foregoing is directed to the preferred embodiment of the present invention, other and further embodiments of the invention may be devised without departing from the basic scope thereof. For example, the equations presented in the above specification are of a specific form and may be factored to other forms and still represent equivalent equations. Therefore, the scope of the present invention is determined by the claims that follow.

What is claimed is:

1. A method of processing a plurality of acquired samples of a signal under test from a device under test comprising the steps:
acquiring a plurality of samples in the time domain of a signal under test from a device under test via a signal path including a plurality of impedance loads selectively coupled in the signal path;
converting the plurality of samples in the time domain of a signal under test to a spectral domain representation for each selected impedance load of the plurality of impedance loads;
characterizing transfer parameters of the device under test within a spectral domain from the spectral domain representation for each selected impedance load of the plurality of impedance loads;
retrieving a stored value representing a reference impedance Z_{ref} associated with the transfer parameters;
processing the transfer parameters of the device under test with the reference impedance (Z_{ref}) in the spectral domain to effect thereby a representation of the device under test impedance (Z_{eq}) as a function of frequency.

2. The method of processing a plurality of acquired samples of a signal under test from a device under test as recited in claim 1, wherein the step of characterizing transfer parameters of the device under test comprises computing, for each of a plurality of load selections, parameters associated with a two-port network representation of the following form:
$$1 = ( \begin{matrix}{Td}_{1} & {Td}_{2}\end{matrix} ) \cdot ( \begin{matrix}{Tu}_{11} & {Tu}_{12} \\ {Tu}_{21} & {Tu}_{22}\end{matrix} ) \cdot ( \begin{matrix}{Tfi}_{11} & {Tfi}_{12} \\ {Tfi}_{21} & {Tfi}_{22}\end{matrix} ) \cdot ( \begin{matrix}{Tp}_{11} & {Tp}_{12} \\ {Tp}_{21} & {Tp}_{22}\end{matrix} ) \cdot ( \begin{matrix}{Ts}_{11} & {Ts}_{12} \\ {Ts}_{21} & {Ts}_{22}\end{matrix} ) \cdot ( \begin{matrix}0 \\ {b}_{is}\end{matrix} )$$

3. The method of processing a plurality of acquired samples of a signal under test from a device under test as recited in claim 2, wherein the step of processing of the transfer parameters of the device under test with the common reference impedance (Z_{ref}) of the transfer parameters in the spectral domain comprises computing the impedance (Z_{eq}) of the device under test using an equation of the following form:
$${Z}_{eq} = ( \frac{2 {Td}_{2}}{{Td}_{1} + {Td}_{2}} - 1 ) \cdot {Z}_{ref}$$

4. The method of processing a plurality of acquired samples of a signal under test from a device under test as recited in claim 3, wherein the converting the plurality of samples in the time domain of a signal under test to a spectral domain representation generates at least a first frequency component having a signal level and the processing of the transfer parameters of the device under test with the reference impedance (Z_{ref}) in the spectral domain further comprises the steps of:
defining a threshold signal level;
comparing the threshold signal level to the signal level of at least the first frequency component; and
computing the impedance (Z_{eq}) of the device under test when the signal level of at least the first frequency component is greater than the threshold level.

5. The method of processing a plurality of acquired samples of a signal under test from a device under test as recited in claim 3, wherein the converting the plurality of samples in the time domain of a signal under test to a spectral domain representation generates a plurality of frequency components with each frequency component having a signal level and the processing of the transfer parameters of the device under test with the reference impedance (Z_{ref}) in the spectral domain further comprises the steps of:
defining a threshold signal level;
comparing the threshold signal level to the respective signal levels of plurality of frequency component; and
computing the impedance (Z_{eq}) of the device under test for each of the plurality of frequency components when the respective signal level of each of the plurality of frequency components is greater than the threshold level.

6. The method of processing a plurality of acquired samples of a signal under test from a device under test having a signal source coupled to a passive circuit device (PCD) and comprising the steps of:
acquiring a plurality of samples in the time domain of a signal from the signal source via a signal path including a plurality of impedance loads selectively coupled in the signal path;
converting the plurality of samples in the time domain of a signal under test from the signal source to a spectral domain representation for each selected impedance load of the plurality of impedance loads;
characterizing transfer parameters of the signal source within a spectral domain from the spectral domain representation for each selected impedance load of the plurality of impedance loads;
retrieving a stored value representing a reference impedance Z_{ref} associated with the transfer parameters;
processing the transfer parameters of the signal source with the reference impedance (Z_{ref}) in the spectral domain to effect thereby a representation of the signal source impedance (Z_{eq}^{source}) as a function of frequency;
coupling the signal source to the passive circuit device;
acquiring a plurality of samples in the time domain of a signal under test from the passive circuit device via a signal path including a plurality of impedance loads selectively coupled in the signal path;
converting the plurality of samples in the time domain of a signal under test from the passive circuit device to a spectral domain representation for each selected impedance load of the plurality of impedance loads;
characterizing transfer parameters of the passive circuit device combined with the signal source within a spectral domain from the spectral domain representation for each selected impedance load of the plurality of impedance loads;
processing the transfer parameters of the combined signal source and the passive circuit device with the reference impedance (Z_{ref}) in the spectral domain to effect thereby a representation of the combined signal source and passive circuit device impedance (Z_{eq}^{comb}) as a function of frequency.
processing the representations of the signal source impedance (Z_{eq}^{source}) and the combined signal source impedance and passive circuit device impedance (Z_{eq}^{comb}) in the spectral domain to effect thereby a representation of the passive circuit device impedance (Z_{eq}^{PCD}) as a function of frequency.

7. The method of processing a plurality of acquired samples of a signal under test from a device under test as recited in claim 6, wherein the steps of characterizing transfer parameters of the signal source and the combined signal source and passive circuit device comprises computing, for each of a plurality of load selections, parameters associated with a two-port network representation of the following form:
$$1 = ( \begin{matrix}{Td}_{1} & {Td}_{2}\end{matrix} ) \cdot ( \begin{matrix}{Tu}_{11} & {Tu}_{12} \\ {Tu}_{21} & {Tu}_{22}\end{matrix} ) \cdot ( \begin{matrix}{Tfi}_{11} & {Tfi}_{12} \\ {Tfi}_{21} & {Tfi}_{22}\end{matrix} ) \cdot ( \begin{matrix}{Tp}_{11} & {Tp}_{12} \\ {Tp}_{21} & {Tp}_{22}\end{matrix} ) \cdot ( \begin{matrix}{Ts}_{11} & {Ts}_{12} \\ {Ts}_{21} & {Ts}_{22}\end{matrix} ) \cdot ( \begin{matrix}0 \\ {b}_{is}\end{matrix} )$$

8. The method of processing a plurality of acquired samples of a signal under test from a device under test as recited in claim 6, wherein the step of processing the signal source impedance and the combined signal source impedance and passive circuit device impedance in the spectral domain comprises computing the impedance (Z_{eq}^{PCD}) of the passive circuit device using an equation of the following form:
$${Z}_{eq}^{PCD} = ( \frac{{Z}_{eq}^{source} \cdot {Z}_{eq}^{comb}}{{Z}_{eq}^{source} - {Z}_{eq}^{comb}} )$$

9. The method of processing a plurality of acquired samples of a signal under test from a device under test as recited in claim 6, wherein the converting the plurality of samples in the time domain of a signal from the signal source and the signal under test of the combined signal source and the passive circuit device to spectral domain representations generates at least a first frequency component having a signal level for each of the spectral representations and the processing of the transfer parameters of the signal source and the combined signal source and the passive circuit device with the reference impedance (Z_{ref}) in the spectral domain further comprises the steps of:
defining a threshold signal level;
comparing the threshold signal level to the signal level of at least the first frequency component of each of the spectral domain representations of the signal source and the combined signal source and the passive circuit device; and
computing the impedance (Z_{eq}^{source}) of the signal source when the signal level of at least the first frequency component of the spectral domain representation of the signal source is greater than the threshold level and computing the impedance (Z_{eq}^{comb}) of the combined signal source and the passive circuit device when the signal level of at least the first frequency component of the spectral domain representation of the combined signal source and the passive circuit device is greater than the threshold level.

10. The method of processing a plurality of acquired samples of a signal under test from a device under test as recited in claim 6, wherein the converting of the plurality of samples in the time domain from the signal source and the signal under test of the combined signal source and the passive circuit device to spectral domain representations generates a plurality of frequency components for each of the spectral domain representations with each frequency component having a signal level and the processing of the transfer parameters of the signal source and the combined signal source and the passive circuit device with the reference impedance (Z_{ref}) in the spectral domain further comprises the steps of:
defining a threshold signal level;
comparing the threshold signal level to the respective signal levels of the plurality of frequency components of each of the spectral domain representations of the signal source and the combined signal source and the passive circuit device; and
computing the impedance (Z_{eq}^{source}) of the signal source when the signal level of at least the first frequency component of the spectral domain representation of the signal source is greater than the threshold level and computing the impedance (Z_{eq}^{comb}) of the combined signal source and the passive circuit device when the signal level of at least the first frequency component of the spectral domain representation of the combined signal source and the passive circuit device is greater than the threshold level.
computing the impedance (Z_{eq}^{source}) of the signal source for each of the plurality of frequency components of the spectral domain representation of the signal source when the signal level of the frequency component is greater than the threshold level and computing the impedance (Z_{eq}^{comb}) of the combined signal source and the passive circuit device of the spectral domain representation of the combined signal source and passive circuit device when the signal level of the frequency component is greater than the threshold level.

11. A signal analysis system for processing acquired time domain digital samples of a signal under test from a device under test to represent an impedance of the device under test comprising:
a digitizing instrument having a memory for storing transfer parameters associated with the digitizing instrument and acquiring time domain digital samples of an incoming signal under test;
a test probe providing the signal under test to the digitizing instrument, the test probe having associated with it a memory for storing transfer parameters associated with the probe, and a controllable impedance device having selectable impedance loads selectively coupled to the device under test; and
a controller having associated memory communicating with the digitizing instrument and the test probe for selectively coupling impedance loads in the controllable impedance device to the device under test and receiving the acquired time domain digital samples of the incoming signal under test and converting the time domain digital samples to a spectral domain representation for each selected impedance load, and characterizing the transfer parameters of the device under test within a spectral domain from the spectral domain representations for each selected impedance load, the controller retrieving a stored value representing a reference impedance Z_{ref} associated with the transfer parameters and computing at least a first impedance (Z_{eq}) of the device under test as a function of frequency using the characterized transfer parameters of the device under test and the reference impedance (Z_{ref}).

12. The signal analysis system as recited in claim 11 further comprising a display device for displaying the computed impedance (Z_{eq}) of the device under test.

13. The signal analysis system as recited in claim 12 wherein the digitizing instrument further comprises a digital oscilloscope.

14. The signal analysis system as recited in claim 13 wherein the controller is disposed in the digital oscilloscope and controls the acquisition of the time domain digital samples of the signal under test and the display of the computed impedance (Z_{eq}) of the device under test.

15. The signal analysis system as recited in claim 11 wherein the transfer parameters of the digitizing instrument and the test probe comprise at least one of S-parameters and T-parameters.

16. The signal analysis system as recited in claim 11 wherein the reference impedance (Z_{ref}) associated with the transfer parameters comprises an impedance in which the probe and digitizing instrument transfer parameters are derived.
